(19) United States
(12) Patent Application Publication
(10) Pub. No.: US 2022/0394989 A1
(43) Pub. Date: Dec. 15, 2022

(54) Plant-Based Cream Cheese Product and Method of Making a Plant-Based Cream Cheese Product

(71) Applicant: Kraft Foods Group Brands LLC, Chicago, IL (US)

(72) Inventors: Madeline Erickson Goris, Chicago, IL (US); Andrew E. McPherson, Mount Prospect, IL (US); Jennifer Sakurai, Foster City, CA (US); Andrea Thyen, Foster City, CA (US)

(21) Appl. No.: 17/837,632

(22) Filed: Jun. 10, 2022

Related U.S. Application Data
(60) Provisional application No. 63/209,838, filed on Jun. 11, 2021.

(51) Int. Cl. A23C 20/02; A23L 29/212; A23L 29/238

(52) U.S. Cl. CPC A23C 20/025; A23L 29/212; A23L 29/238

(57) ABSTRACT

A plant-based cheese product, particularly cream cheese type products, is provided herein. The plant-based cheese products are in the form of an emulsion comprising a plant-based protein, a stabilizer, a starch-based thickening agent, and a fat component. The plant-based cheese has a spreadable texture and opaque appearance at both refrigerated and elevated temperatures.

### CROSS REFERENCE TO RELATED APPLICATION

This application claims the benefit of U.S. Provisional Application No. 63/209,838, filed on Jun. 11, 2021, which is incorporated herein by reference in its entirety.

### FIELD

This application relates generally to plant-based soft cheese products, including plant-based cream cheese products.

### BACKGROUND

Some commercially available plant-based cheese products have been able to replicate certain attributes of dairy-based cream cheese products. However, plant-based cheese cream products often do not have the appearance, taste, or texture expected of dairy-based cream cheeses, including spreadability. Indeed, some plant-based cream cheese products do not have a smooth, creamy texture and may be difficult to spread. Further, currently available plant-based cream cheese products often have off-notes or aftertastes. These plant-based cream cheese products are not as well accepted by consumers who expect a cooking and eating experience that replicates dairy-based cheeses.

### BRIEF DESCRIPTION OF THE DRAWINGS

The patent or application file contains at least one drawing executed in color. Copies of this patent or patent application publication with color drawings will be provided by the office upon request and payment of the necessary fee.

FIG. 1 is a schematic diagram of a process for making a plant-based cheese product according to some embodiments;

FIG. 2 is a colored photograph of a substrate with a cream cheese type plant-based food product spread thereon;

FIG. 3 is a colored photograph of two exemplary cream cheese type plant-based food products;

FIG. 4 is a colored photograph of a substrate with example and comparative example cream cheese type plant-based food products spread thereon;

FIG. 5 and FIG. 6 are light microscopy images, with a 100 μm scale bar, of a comparative example cream cheese type plant-based food product;

FIG. 7 is a light microscopy image, with a 100 μm scale bar, of a comparative example cream cheese type plant-based food product;

FIG. 8 and FIG. 9 are light microscopy images, with a 100 μm scale bar, of an example cream cheese type plant-based food product;

FIG. 10 and FIG. 11 are light microscopy images, with a 100 μm scale bar, of an example cream cheese type plant-based food product;

FIG. 12 is a graph of fat droplet size distribution of example and comparative example cream cheese type plant-based food products illustrating the frequency distribution percentage (Y axis) as a function of the diameter of the samples (μm, X axis);

FIG. 13 is a graph of fat droplet size distribution of example and comparative example cream cheese type plant-based food products illustrating the cumulative distribution percentage (Y axis) as a function of the diameter of the samples (μm, X axis);

FIG. 14 is a colored macrograph of a substrate with example and comparative example cream cheese type plant-based food products spread thereon;

FIG. 15 is a graph of the light intensity of example and comparative example cream cheese type plant-based food products illustrating the light intensity of the samples (Y axis) as a function of line position (X axis);

FIG. 16 is a graph of the mean intensity of example and comparative example cream cheese type plant-based food products illustrating the mean intensity of the samples (Y axis) as a function of area (X axis);

FIG. 17 is a graph produced from rheometer temperature sweeps of example and comparative example cream cheese type plant-based food products illustrating firmness of the samples (Pa, Y axis) over temperature (° C., X axis);

FIG. 18 is a graph produced from rheometer temperature sweeps of example and comparative example cream cheese type plant-based food products illustrating viscosity of the samples (Pa·s, Y axis) over temperature (° C., X axis);

FIG. 19 is a graph produced from rheometer temperature sweeps of example and comparative example cream cheese type plant-based food products illustrating Tan δ of the samples (Y axis) over temperature (° C., X axis)

FIG. 20 is a colored photograph of example and comparative example cream cheese type plant-based food products;

FIG. 21 is a scatter plot illustrating the a* (green-red) value (Y axis) and b* (blue-yellow) value (X axis) of example and comparative example cream cheese type plant-based food products; and

FIG. 22 is a bar graph illustrating the L* (Lightness) value of example and comparative example cream cheese type plant-based food products.

Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Described herein is a plant-based cheese product, which, in some approaches, may be in the form of a soft plant-based cheese product, such as a plant-based cream cheese product or plant-based cheese spread. As used herein, the term “plant-based” refers to a product or ingredient that is free of animal-based proteins, such as dairy proteins, and comprises a plant-derived protein.

In one particular approach, the plant-based cheese products have an appearance, taste, and texture similar to a dairy-based cream cheese. In one aspect, the plant-based cheese products are in the form of a stable emulsion. In this respect, the fat droplets are homogeneously dispersed in the plant-based cheese products and no or minimal phase separation (syneresis) occurs for at least about four weeks, in another aspect at least about 8 weeks, and in another aspect at least about 12 weeks storage at refrigeration temperatures.

Dairy-based cream cheeses are generally characterized by a soft, smooth texture and relatively high fat content (e.g., about 23-35 percent fat by weight of the finished product). However, the plant-based cream cheese products provided herein deliver the desired soft texture and spreadability of a conventional dairy-based cream cheese product and, in some approaches, effective to do so at lower amounts of fat than in the conventional dairy-based cream cheese products. Further, as the plant-based cheese product disclosed herein may be free of animal-based proteins (including dairy-based proteins), animal-based proteins cannot be relied upon to produce the desired texture, including spreadability at refrigeration temperatures of conventional cream cheeses. Rather, it has been unexpectedly found that a plant-based cheese product with characteristics consistent with consumer expectations for a dairy-based cream cheese product could be obtained through the combination of a plant-based protein, a stabilizer, a starch-based thickening agent, and a fat component. The plant-based cheese product is further characterized by a desirable opaque appearance at both refrigerated and elevated temperature, such as a temperature at which the product is likely to be consumed (e.g., cream cheese on a toasted bagel). The plant-based cheese products described herein are uniquely able to maintain opacity at elevated temperatures (e.g., up to about 55° C.).

In some approaches, the plant-based cream cheese product includes a plant-based protein, a stabilizer, a starch-based thickening agent, and a fat component. In some approaches, a method of making the plant-based cheese product includes mixing water, a plant-based protein, a thickening agent, a stabilizer, and a fat component to form a mixture. In some examples, the method may further include heating the mixture to a temperature within the range of about 150° F. to about 200° F., such as via direct steam injection, to pasteurize the mixture; and homogenizing the heated mixture to form the plant-based cheese product in the form of a stable emulsion. In other examples, the method may include heating the mixture to a temperature within the range of about 150° F. to about 200° F. via indirect steam injection to pasteurize the mixture; and homogenizing the heated mixture to form the plant-based cheese product. The heating, such as by injecting steam (directly or indirectly), may occur before the homogenizing. The method may further include cooling the plant-based cheese product to refrigeration temperature.

In other approaches, a method of making the plant-based cheese product includes adding a plant-based protein to water to form a first mixture. The method may further include melting the fat component and adding the melted fat component, a stabilizer, and a thickening agent to the first mixture and mixing to form a second mixture. The second mixture is then heated to pasteurize the mixture, and then homogenizing the second mixture to form the plant-based cheese product in the form of a stable emulsion. In some examples, the heating includes injecting steam directly into the second mixture to pasteurize the second mixture, and homogenizing the second mixture to form the plant-based cheese product. In other examples, the method includes indirect steam heating of the second mixture to pasteurize the second mixture (e.g., via use of a thermally jacketed heating vessel), and homogenizing the second mixture to form the plant-based cream cheese product. The heating by steam (directly or indirectly) may occur before homogenization. In some methods, it has been found that direct versus indirect steam injection can provide slightly different final color and flavor differences to the plant-based cream cheese products. Therefore, in some methods, direct steam injection may be advantageous to avoid introduction of off colors and flavors to the product.

At least in some approaches, the method of making the plant-based cheese products specifically do not include a fermentation step and the resulting plant-based cheese product may be characterized as a non-fermented plant-based cheese product. As used herein, the terms “fermentation,” “fermented,” and the like refer to a process involving incubating a substrate, such as a carbohydrate, in the presence of a microorganism for a period of time in which the microorganism converts the substrate into an alcohol or acid. For example, in lactic acid fermentation, a starch or sugar is converted to lactic acid by yeast or bacterial strains. At least in some approaches, the present methods and plant-based cheese products do not include a lactic acid fermentation step.

In other approaches, the method of making the plant-based cheese products may include a fermentation step. In these approaches, lactic acid bacteria (i.e., bacteria that produce lactic acid as a product of fermentation) may be used. For example, any Lactococcus lactis, Lactococcus cremoris, Streptococcus lactis, Streptococcus thermophilus, Lactobacillus helveticus, and Lactobacillus bulgaricus may be used. Fermentation is generally carried out until a desired pH is achieved (e.g., between about 3.5 to about 5.0, in another aspect about 3.8 to about 4.8, and in another aspect about 4.0 to about 4.4).

The plant-based cheese product described herein may be formed into any desirable shape. In some examples, the plant-based cheese product is a cream cheese product that is formed into a soft block or filled into a container.

The plant-based cheese product includes a plant-based protein. Any suitable plant-based protein may be used in the plant-based cheese product. In some aspects, the plant-based protein comprises one or more of faba bean protein (also known as fava bean protein), soy protein, lentil protein, potato protein, chickpea protein, canola protein, and pea protein. It has been found that some plant-based proteins may impart off color or off flavor to the resulting plant-based cheese product. Therefore, in some approaches, the plant-based protein is selected based on the impact of the plant-based protein on the color and/or flavor of the final plant-based cheese product. For example, it has been found that soy protein, faba bean protein, and chickpea protein products may be particularly suitable for cream cheese applications. Faba bean, soy, or chickpea protein resulted in final products closer in color to conventional dairy-based cream cheese, while inclusion of pea or lentil protein resulted in cheese products with a more yellow or tan color, and inclusion of potato protein resulted in cheese products with a gray hue.

The plant-based protein may be in the form of an isolate, a concentrate, or a flour. In some approaches, the plant-based protein is in the form of an isolate or a concentrate that contributes to emulsification of the plant-based cheese product. While not wishing to be limited by theory, it is presently believed that other non-protein components of the protein isolate or concentrates may beneficially contribute to the texture of the cheese product. In some aspects, the plant-based protein is the only source of protein in the plant-based cheese product. In this respect, the plant-based cheese product includes no animal- or dairy-based proteins, including, for example, casein and whey.

In some aspects, the plant-based cheese product includes no nut-based proteins, including, for example, one or more of almond protein, peanut protein, and cashew protein. Additionally, or alternatively, the plant-based cheese product may be free of one or more of oat protein, rice protein, wheat protein, and/or sunflower seeds.

In one approach, the plant-based protein is present in an amount within the range of about 0.2 wt % to about 8 wt % crude protein, in another aspect about 0.25 wt % to about 8 wt % crude protein, in another aspect about 0.3 wt % to about 8 wt % crude protein, in another aspect about 0.35 wt % to about 8 wt % crude protein, in another aspect about 0.2 wt % to about 6 wt % crude protein, in another aspect about 0.25 wt % to about 6 wt % crude protein, in another aspect about 0.3 wt % to about 6 wt % crude protein, in another aspect about 0.35 wt % to about 6 wt % crude protein, in another aspect about 0.2 wt % to about 5 wt % crude protein, in another aspect about 0.25 wt % to about 5 wt % crude protein, in another aspect about 0.3 wt % to about 5 wt % crude protein, in another aspect about 0.35 wt % to about 5 wt % crude protein, in another aspect about 0.2 wt % to about 4 wt % crude protein, in another aspect about 0.25 wt % to about 4 wt % crude protein, in another aspect about 0.3 wt % to about 4 wt % crude protein, in another aspect about 0.35 wt % to about 4 wt % crude protein, in another aspect about 0.25 wt % to about 3.5 wt % crude protein, in another aspect about 0.25 wt % to about 3 wt % crude protein, in another aspect about 0.3 wt % to about 3 wt % crude protein, in another aspect about 0.35 wt % to about 3 wt % crude protein, in another aspect about 0.25 wt % to about 2.5 wt % crude protein, in another aspect about 0.3 wt % to about 2 wt % crude protein, in another aspect about 0.35 wt % to about 2 wt % crude protein, in another aspect about 0.25 wt % to about 1.75 wt % crude protein, in another aspect about 0.25 wt % to about 1.55 wt % crude protein, in another aspect about 0.25 wt % to about 1.5 wt % crude protein, in another aspect about 0.3 wt % to about 1.5 wt % crude protein, in another aspect about 0.35 wt % to about 1.5 wt % crude protein, and in another aspect about 0.25 wt % to about 1.0 wt % crude protein, in another aspect about 0.3 wt % to about 1.0 wt % crude protein, in another aspect about 0.35 wt % to about 1.0 wt % crude protein, based on a total weight of the plant-based cheese product.

The amount of crude protein in a plant-based protein ingredient may depend on the form of the protein-containing ingredient (e.g., whether the ingredient is in the form of an isolate, a concentrate, or a flour). Thus, for purposes herein, the amount of crude protein is the amount of protein contributed by any protein-containing ingredient. For example, the commercially available VITESSENCE™ Pulse 3600 (Ingredion) faba bean protein product includes about 60% protein and about 40% non-protein components. If a plant-based cheese product includes about 2 wt % VITESSENCE™ Pulse 3600 faba bean protein product, the plant-based cheese product will include about 1.2 wt % crude protein, for purposes herein. The amount of crude protein in a plant-based protein ingredient or in the plant-based cheese product may be measured by the Association of Official Analytical Chemists (AOAC) Official Method 992.15 (which is incorporated herein by reference in its entirety). Additionally, or alternatively, the amount of crude protein in a plant-based protein ingredient or in the plant-based cheese product may be measured by the Dumas Method.

In some approaches, the plant-based protein may be the only emulsifier in the plant-based cheese product. In this respect, in some aspects, the plant-based cheese product is free from lecithin, monoglycerides, diglycerides, polyethylene glycol, propylene glycol alginate, and polysorbate. In other approaches, the plant-based cheese product may also be free of any one or more of glucono-Delta-Lactone, tricalcium phosphate, sugar, beta Carotene (color), and sodium citrate.

In some approaches, the inclusion of a plant-based protein, and in particularly in combination with a stabilizer and a starch-based thickener, has surprisingly been found to provide significant benefits to the appearance and performance of the plant-based cheese product. The stabilizer, starch-based thickener, and fat component interact with the plant-based protein in the final food product to contribute to the opacity of the product. For example, plant-based cheese products prepared without a plant-based protein may have a white appearance and opacity at refrigeration temperature but a thinner hot viscosity that results in a loss of opacity when the plant-based cheese product is applied on a hot substrate. By contrast, when a plant-based cheese products is prepared with a plant-based protein in combination with the stabilizer, starch-based thickener, and fat component as described herein, the product maintains its opacity when applied on a hot substrate, such as a slice of toasted bread or bagel. It is presently believed that the plant-based protein stabilizes the product matrix and maintains smaller droplets of the fat component. The plant-based protein and starch-based thickener molecules contribute to light scattering at elevated temperatures. The inclusion of a plant-based protein also allows for lower percent of light transmission at a wavelength of 865 nm.

Additionally, the stabilizer, starch-based thickener, and fat component interact with the plant-based protein in the final food product to contribute to the texture of the product. For example, at refrigeration temperature, plant-based cheese products prepared without a plant-based protein may have a soft, smooth texture similar to a dairy-based cream cheese, but a thinner, less firm texture at temperatures above 25° C. By contrast, when a plant-based cheese product is prepared with a plant-based protein in combination with the stabilizer, starch-based thickener, and fat component as described herein, the product retains more firmness, emulsion stability, and opacity than a similar plant-based cheese product but that was prepared without a plant-based protein.

The plant-based cheese product further includes a fat component having a solid fat content at 10° C. of about 50% to about 90%, in another aspect about 55% to 90%, in another aspect about 55% to about 85%, and in another aspect about 60% to about 85%, and a solid fat content at 20° C. of about 15% to about 45%, in another aspect about 20% to about 45%, in another aspect of about 20 to about 40%, and in another aspect about 25% to about 40%.

In another approach, the fat component has a solid fat content of about 50% to about 90% at 10° C. and a solid fat content of about 15% to about 45% at 20° C., in another aspect a solid fat content of about 55% to about 90% at 10° C. and a solid fat content of about 20% to about 45% at 20° C., in another aspect a solid fat content of about 55% to about 85% at 10° C. and a solid fat content of about 20% to about 45% at 20° C., and yet another aspect a solid fat content of about 60% to about 85% at 10° C. and a solid fat content of about 25% to about 40% at 20° C.

In some approaches, when the fat component has a solid fat content within the specified ranges, the fat component may behave functionally similarly to butterfat, which may contribute to the plant-based cheese product having a flavor profile, cold texture, and melt profile similar to a dairy-based cheese. In some aspects, the solid fat content of the fat component may be measured by differential scanning calorimetry (DSC). In differential scanning calorimetry, a 10 mg sample in a hermetically sealed pan may be heated from −500° C. to 1000° C. at a heating rate of 10° C./minute, and the heat flow rate may be measured as a function of temperature. From the heat flow vs. temperature curve, a solid fat content vs. temperature curve may be calculated.

Any suitable fat component comprising one or more solid fats, liquid oils, or combination thereof having the specified solid fat content may be used. In some examples, the fat component comprises one or more of vegetable- or plant-based oils, such as coconut oil, palm oil, palm oil fraction, shea butter, and shea olein. In some of these examples, the fat component further comprises one or more of soybean oil, sunflower oil, olive oil, canola oil, peanut oil, sesame oil, and corn oil to provide a blend of ingredients to provide the desired solid fat content at the respective temperatures. At least in some aspects, the oil is a refined oil (e.g., refined coconut oil). In other examples, the fat component comprises a combination of coconut oil and sunflower oil, for example, the commercially available AKOVEG™ oil (sold by AAK USA Inc.). In still other examples, the fat component comprises coconut oil. Additionally, or alternatively, the plant-based cheese product may be free from palm oil and palm oil fraction.

In one approach, the fat component is present in an amount within the range of about 10 wt % to about 50 wt %, in another aspect about 10 wt % to about 45 wt %, in another aspect about 15 wt % to about 40 wt %, in another aspect about 15 wt % to about 35 wt %, in another aspect about 15 wt % to about 25 wt %, and in another aspect about 20 wt % to about 30 wt %, based on a total weight of the plant-based cheese product.

The plant-based cheese product further includes a stabilizer. The stabilizer may be any suitable hydrocolloid or fiber. As used herein, the stabilizer assists with water management and texture of the plant-based cheese product. In some aspects, the hydrocolloid includes one or more of inulin, pectin, carboxymethylcellulose, carrageenan, gum Arabic, xanthan gum, locust bean gum, and guar gum. In one aspect, the hydrocolloid comprises a combination of xanthan gum, locust bean gum, and guar gum, such as the commercially available TIC Stabilizer 424 (Ingredion). In another aspect, the hydrocolloid comprises locust bean gum. In some aspects, the fiber is a vegetable fiber, and particularly insoluble fiber. Suitable vegetable fibers include, for example, flax fiber, hemp fiber, and jute fiber. One exemplary flax fiber is HI-SMOOTH® (flax fiber from HIFOOD, Parma, Italy). The stabilizer may act as an emulsion stabilizer in the plant-based cheese product. In some aspects, the stabilizer may also provide a thickening function.

In one approach, the stabilizer is present in an amount within the range of about 0.01 wt % to about 10 wt %, in another aspect about 0.01 wt % to about 5 wt %, in another aspect about 0.01 wt % to about 1 wt %, in another aspect about 0.05 wt % to about 1 wt %, in another aspect about 0.1 wt % to about 5 wt %, in another aspect about 0.25 wt % to about 5 wt %, in another aspect about 0.1 wt % to about 3 wt %, in another aspect about 0.25 wt % to about 3 wt %, in another aspect about 0.1 wt % to about 2 wt %, in another aspect about 0.25 wt % to about 2 wt %, and in another aspect about 0.1 wt % to about 1 wt %, in another aspect about 0.25 wt % to about 1 wt % stabilizer, based on a total weight of the plant-based cheese product.

The plant-based cheese product further includes a thickening agent, such as a starch-based thickening agent. The thickening agent can contribute to desired texture of the plant-based cheese product. Suitable thickening agents include, for example, starches such as potato starch, corn starch, tapioca starch, arrowroot starch, or rice starch. In one aspect, the starch is shear tolerant. As used herein, the term “shear tolerant” means that the starch is able to withstand homogenization (e.g., single stage homogenization at 165 bar in a GEA Twin Panda Dynamic Homogenizer) at a temperature of 82° C. in order to contribute a measurable increase in viscosity to the final product upon cooling to 5° C. As used herein, “measurable increase in viscosity” means an at least 5% (or in some aspects at least 10%) increase in complex viscosity upon cooling as compared to an otherwise identical product made without a starch-based thickening agent and including additional water in place of the starch-based thickening agent. In some aspects, the starch is a modified starch, such as an enzymatically converted or acid-thinned starch. In some examples, the starch is an enzymatically-converted potato starch, such as the commercially available ETENIA™ 457 starch (Cooperatie Avebe U.A.). In one aspect, the starch is or comprises a low dextrose equivalent (DE) maltodextrin, such as having a DE of 10 or less, in another aspect a DE of 5 or less, in another aspect a DE of 3 or less, and in another aspect a DE of 2. In some aspects, the starch is thermoreversible such that it is flowable at hot temperatures and sets as it cools. In this manner, a thermoreversible starch may provide a spreadable texture to a cooled plant-based cheese product.

The inclusion of a thickening agent may contribute to the textural characteristics of the plant-based cheese product. Inclusion of a thickening agent may provide textural characteristics that replicate a dairy-based cheese product. For example, the thickening agent may provide a texture that is firm enough to scoop, spread, and quickly dissipate in the mouth.

In some approaches, the starch-based thickening agent is present in an amount within the range of about 1 wt % to about 25 wt %, based on a total weight of the plant-based cheese product. In another approach, the thickening agent is present in an amount within the range of about 1 wt % to about 20 wt %, in another aspect about 1 wt % to about 15 wt %, in another aspect about 1 wt % to about 12 wt %, in another aspect about 3 wt % to about 10 wt %, in another aspect about 3 w % to about 8 wt %, based on a total weight of the plant-based cheese product.

The plant-based cheese product further includes water. In some aspects, the plant-based cheese product includes water in an amount effective to provide a moisture % of the plant-based cheese product within the range of about 50 wt % to about 80 wt %, in another aspect about 50 wt % to about 75 wt %, in another aspect about 55 wt % to about 75 wt %, in another aspect about 55 wt % to about 70 wt %, or in another aspect about 60 wt % to about 70 wt %, by weight of the plant-based cheese product.

The plant-based cheese product may further include an acidulant. In some aspects, the plant-based cheese product includes an acidulant in an amount effective to provide a pH in the plant-based cheese product of about 3.5 to about 5.0, in another aspect about 3.8 to about 4.8, and in another aspect about 4.0 to about 4.4. Any suitable acidulant may be used. Suitable acids include malic acid, citric acid, acetic acid, phosphoric acid, and lactic acid. In one example, the acidulant comprises one or more of citric acid, sorbic acid, and lactic acid. The inclusion of the acidulant to a provide a pH in the described ranges contributes to microbial stability of the product as well as providing desirable flavor. The acidulant may be separately added to the ingredients of the plant-based cheese product and/or the acidulant may be generated via a fermentation step. For example, lactic acid may be generated during fermentation with an acid-generating bacteria, such as lactic acid bacteria.

In some aspects, the plant-based cheese product may further include one or more additional ingredients, such as salt, a preservative (e.g., sorbic acid), a colorant, and flavors. Any suitable natural or artificial flavors may be used, such as one or more of garlic, herbs (e.g., chives, parsley, basil), spices (e.g., cinnamon), fruit (e.g., strawberry, blueberry, pineapple, peach, and the like), nuts (e.g., pecan), pepper (e.g., jalapeno, chipotle, bell pepper), sweetener (e.g., honey, brown sugar, sucrose), olive, bacon, salmon, and vegetable (e.g., onion). In some aspects, the one or more flavors include a masking-type flavor to mask the taste of another ingredient in the plant-based food product. In another aspect, one or more flavors may be included to build back positive dairy notes to replicate the taste of a dairy-based cheese product.

In some aspects, the plant-based cheese product may be free from one or more of nut-based proteins, almond protein, peanut protein, cashew protein, oat protein, rice protein, wheat protein, sunflower seeds, non-plant-based protein emulsifiers, lecithin, monoglycerides, diglycerides, polyethylene glycol, propylene glycol alginate, polysorbate, palm oil, and palm oil fraction.

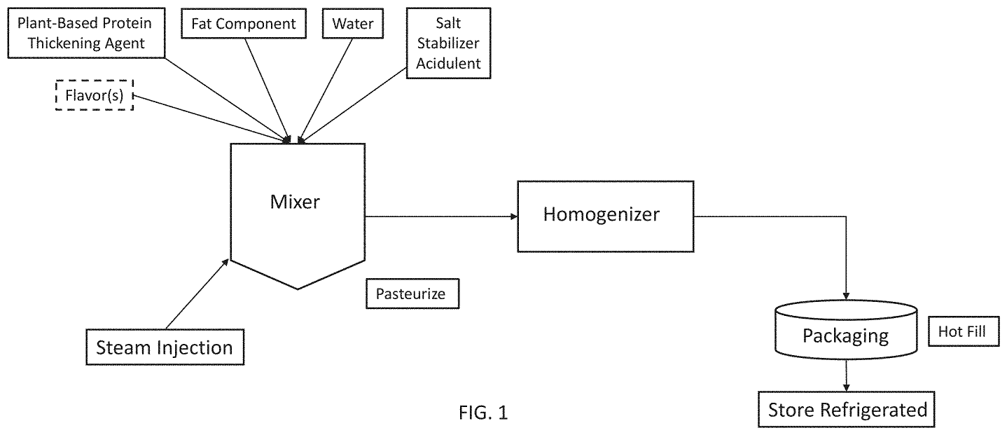

The plant-based cheese products described herein can be made by a variety of methods. Turning to FIG. 1, in one approach, the plant-based cheese products can be made by a method comprising combining a plant-based protein, a fat component, a starch-based thickening agent, water, a stabilizer, and an acidulant to form a mixture. In some approaches, the fat component may be melted, such as in a cooker, before it is added to the mixture. Other optional ingredients such as flavors or salt may be added at this point or later in the process. The ingredients are mixed in a mixer. The ingredients may be mixed in a mixer having direct steam injection capabilities by which steam may be injected directly into the product mixture. In this manner, the ingredients may be heated via direct steam injection while mixing. In direct steam injection, steam is introduced directly into or above the product mixture in the mixing vessel. As such, with direct steam injection, steam may condense into the product mixture and contribute to moisture levels in the product mixture. In indirect steam injection, steam is separate from the product mixture and heats the product mixture indirectly by contacting a surface in thermal communication with the product mixture, such as a steam jacketed mixing vessel. In some approaches, the mixture of ingredients is heated for a time and to a temperature effective to pasteurize the mixture, such as to a temperature within the range of about 150° F. to about 200° F., about 160° F. to about 200° F., about 160° F. to about 190° F., or in some aspects about 170° F. to about 190° F., for a time period of, for example, about 1 second to about 5 minutes. High-temperature-short-time pasteurization methods may also be used, if desired. In general, the time of the heat treatment may depend in part on the temperature of the heat treatment. In some aspects, the starch-based thickening agent may gelatinize before the mixture is heated to such temperatures and heating may primarily act to pasteurize the mixture. In other aspects, heating may both pasteurize the mixture and gelatinize the starch-based thickening agent. In some approaches, the pasteurization treatment is carried out while continuing to mix the product.

At least in some approaches, it is contemplated that heating the mixture via direct steam injection as opposed to indirect steam injection may improve the appearance of the final plant-based cheese product. In particular, heating the mixture via direct steam injection may provide a color and shine of the final plant-based cheese product that more closely imitates the color and shine of a dairy-based cheese product. For example, heating the mixture via direct steam injection may provide an off-white color and reduce browning as compared to indirect steam heating (e.g., when a fermentation step is used). Further, heating the mixture via direct steam injection may provide a shiny, wet appearance which may be desirable for the final plant-based cheese product.

In some aspects, the ingredients may be mixed in a mixer having indirect steam injection capabilities. The ingredients may be heated via indirect steam injection while mixing. In some approaches, the mixture of ingredients is heated for a time and to a temperature effective to pasteurize the mixture and/or gelatinize the starch-based thickening agent (as described above). It is contemplated that in these aspects, a plant-based cheese product having an appearance replicating that of a dairy-based cheese product (e.g., a desirable opaque appearance at elevated temperature) may be achieved.

The mixture is then homogenized or treated with high shear to provide the plant-based cheese product. For purposes herein, the term “homogenize” is used to encompass both homogenization and high shear treatments capable of providing a homogenous mixture. The mixture may be homogenized using any suitable equipment to provide a smooth texture to the plant-based cheese product, for example, via a homogenizer or a shear pump. In some aspects, homogenization provides a homogenous mixture and may distribute ingredients, such as the stabilizer, evenly throughout the product. It is contemplated that homogenization may provide a smooth texture in the plant-based cheese product. In some aspects, the plant-based cheese product may be characterized as an emulsion.

In some approaches, the mixture is homogenized at an elevated pressure, that is, a pressure greater than atmospheric pressure. In some aspects, the mixture is homogenized at pressure within the range of about 100 psi to about 3000 psi, about 100 psi to about 2000 psi, about 500 psi to about 3000 psi, about 500 psi to about 1500 psi, about 700 psi to about 1300 psi, about 800 psi to about 2500 psi, or about 800 psi to about 1200 psi. The pressure selected may depend in part on the particular equipment used. Any suitable pressure that provides a desired smooth texture to the plant-based cheese product may be used. In some examples, a GEA Twin Panda Dynamic Homogenizer may be used.

In some aspects, the plant-based cheese product has a fat droplet size distribution that enables the plant-based cheese product to have, at elevated temperatures, an opaque appearance and/or a soft, smooth texture similar to a dairy-based cream cheese. The fat droplet size distribution may be measured using a Bruker time-domain nuclear magnetic resonance droplet size analyzer (Bruker TD-NMR droplet size analyzer). A decay curve (intensity vs. time) of the NMR field may be used to derive the fat droplet size distributions.

In one aspect, the mixture may be homogenized to achieve a D50 (i.e., 50% of the fat droplets diameters are below this value) at 40° C. of 7 μm or less, in another aspect 6.75 μm or less, in another aspect 6.5 μm or less, in another aspect 6.25 μm or less, in another aspect 6.0 μm or less.

In another aspect, the mixture may be homogenized to achieve a D50 at 40° C. within the range of about 1.5 μm to about 7 μm, in another aspect within the range of about 1.5 μm to about 6.75 μm, in another aspect within the range of about 1.5 μm to about 6.5 μm, in another aspect within the range of about 1.5 μm to about 6.25 μm, in another aspect within the range of about 1.5 μm to about 6.0 μm.

Additionally to the D50 values, or alternatively, the plant-based cheese product may have width of distribution (i.e., the standard deviation

$$( \frac{D 97.5 - D 2.5}{4} ) ) ,$$

wherein 97.5% of the fat droplets diameters are below the D97.5 and 2.5% of the fat droplets diameters are below the D2.5 value) at 40° C. of 5.0 μm or less, in another aspect 4.5 μm or less, in another aspect 4.0 μm or less, and in another aspect 3.5 μm or less. It is presently believed that the D50 values in combination with the width of distribution of the oil droplet size is most indicative of the emulsion stability of the product.

Additionally, or alternatively, the mixture may be homogenized to achieve a D97.5 (i.e., 97.5% of the fat droplets diameters are below this value) at 40° C. of 16.0 μm or less, or of 15.5 μm or less. Additionally, or alternatively, the mixture may be homogenized to achieve a D2.5 (i.e., 2.5% of the fat droplets diameters are below this value) at 40° C. of 3.0 μm or less, 2.75 μm or less, 2.5 μm or less, 2.25 μm or less, or 2.0 μm or less.

In some aspects, the plant-based cheese product has a complex viscosity at a frequency of 10 rad/s and a temperature of 25° C. and 37° C. that enables the plant-based cheese product to have a soft, smooth texture similar to a dairy-based cream cheese at those temperatures. The temperatures of 25° C. and 37° C. are particularly informative for product performance for a cream cheese type product, as 37° C. represents a temperature of a hot bagel upon which the product may be spread and 25° C. represents a likely temperature of the product when the product is consumed.

The complex viscosity indicates the stability of the emulsion at both 25° C. and 37° C. In some aspects, the plant-based cheese product has a complex viscosity at a frequency of 10 rad/s and a temperature of 25° C. within the range of about 400 Pa·s to about 1200 Pa·s, the range of about 400 Pa·s to about 1150 Pa·s, the range of about 400 Pa·s to about 1000 Pa·s, the range of about 400 Pa·s to about 900 Pa·s, the range of about 400 Pa·s to about 800 Pa·s, the range of about 400 Pa·s to about 750 Pa·s, the range of about 400 Pa·s to about 700 Pa·s, the range of about 400 Pa·s to about 600 Pa·s, the range of about 425 Pa·s to about 1200 Pa·s, the range of about 425 Pa·s to about 1000 Pa·s, the range of about 425 Pa·s to about 900 Pa·s, the range of about 425 Pa·s to about 800 Pa·s, the range of about 425 Pa·s to about 750 Pa·s, the range of about 425 Pa·s to about 700 Pa·s, the range of about 425 Pa·s to about 600 Pa·s, the range of about 450 Pa·s to about 1200 Pa·s, the range of about 450 Pa·s to about 1000 Pa·s, the range of about 450 Pa·s to about 900 Pa·s, the range of about 450 Pa·s to about 800 Pa·s, the range of about 450 Pa·s to about 750 Pa·s, the range of about 450 Pa·s to about 700 Pa·s, the range of about 450 Pa·s to about 600 Pa·s, the range of about 500 Pa·s to about 1200 Pa·s, the range of about 500 Pa·s to about 1000 Pa·s, the range of about 500 Pa·s to about 900 Pa·s, the range of about 500 Pa·s to about 800 Pa·s, the range of about 500 Pa·s to about 750 Pa·s, the range of about 500 Pa·s to about 700 Pa·s, or the range of about 500 Pa·s to about 600 Pa·s.

Additionally, or alternatively, the plant-based cheese product may have a complex viscosity at a frequency of 10 rad/s and a temperature of 37° C. within the range of about 300 Pa·s to about 1000 Pa·s, the range of about 300 Pa·s to about 750 Pa·s, the range of about 300 Pa·s to about 600 Pa·s, the range of about 300 Pa·s to about 500 Pa·s, the range of about 300 Pa·s to about 400 Pa·s, the range of about 320 Pa·s to about 1000 Pa·s, the range of about 340 Pa·s to about 1000 Pa·s, the range of about 350 Pa·s to about 1000 Pa·s, the range of about 375 Pa·s to about 1000 Pa·s, the range of about 390 Pa·s to about 1000 Pa·s, the range of about 320 Pa·s to about 600 Pa·s, the range of about 350 Pa·s to about 500 Pa·s, or the range of about 375 Pa·s to about 400 Pa·s.

In some aspects, the plant-based cheese product has an elastic modulus at a temperature between 25° C. and 37° C. that enables the plant-based cheese product to have a soft, smooth texture similar to a dairy-based cream cheese at the corresponding temperature. Elastic modulus indicates the relative firmness of the products. In some aspects, the plant-based cheese product has an elastic modulus at a temperature of 25° C. within the range of about 4000 Pa to about 8000 Pa, the range of about 4000 Pa to about 7500 Pa, the range of about 4000 Pa to about 7000 Pa, the range of about 4000 Pa to about 6500 Pa, the range of about 4000 Pa to about 6000 Pa, the range of about 4000 Pa to about 5750 Pa, the range of about 4250 Pa to about 8000 Pa, the range of about 4250 Pa to about 7500 Pa, the range of about 4250 Pa to about 7000 Pa, the range of about 4250 Pa to about 6500 Pa, the range of about 4250 Pa to about 6000 Pa, the range of about 4250 Pa to about 5750 Pa, the range of about 4500 Pa to about 8000 Pa, the range of about 4500 Pa to about 7500 Pa, the range of about 4500 Pa to about 7000 Pa, the range of about 4500 Pa to about 6500 Pa, the range of about 4500 Pa to about 6000 Pa, the range of about 4500 Pa to about 5750 Pa, the range of about 4750 Pa to about 8000 Pa, the range of about 4750 Pa to about 7500 Pa, the range of about 4750 Pa to about 7000 Pa, the range of about 4750 Pa to about 6500 Pa, the range of about 4750 Pa to about 6000 Pa, the range of about 4750 Pa to about 5750 Pa, the range of about 5000 Pa to about 8000 Pa, the range of about 5000 Pa to about 7500 Pa, the range of about 5000 Pa to about 7000 Pa, the range of about 5000 Pa to about 6500 Pa, the range of about 5000 Pa to about 6000 Pa, the range of about 5000 Pa to about 5750 Pa, the range of about 5250 Pa to about 8000 Pa, the range of about 5250 Pa to about 7500 Pa, the range of about 5250 Pa to about 7000 Pa, the range of about 5250 Pa to about 6500 Pa, the range of about 5250 Pa to about 6000 Pa, the range of about 5250 Pa to about 5750 Pa, the range of about 5500 Pa to about 8000 Pa, the range of about 5500 Pa to about 7500 Pa, the range of about 5500 Pa to about 7000 Pa, the range of about 5500 Pa to about 6500 Pa, the range of about 5500 Pa to about 6000 Pa, or the range of about 5500 Pa to about 5750 Pa.

Additionally, or alternatively, the plant-based cheese product may have an elastic modulus at a temperature of 37° C. within the range of about 3000 Pa to about 7000 Pa, the range of about 3000 Pa to about 6000 Pa, the range of about 3000 Pa to about 5500 Pa, the range of about 3000 Pa to about 5000 Pa, the range of about 3000 Pa to about 4500 Pa, the range of about 3000 Pa to about 4000 Pa, the range of about 3150 Pa to about 7000 Pa, the range of about 3150 Pa to about 6000 Pa, the range of about 3150 Pa to about 5500 Pa, the range of about 3150 Pa to about 5000 Pa, the range of about 3150 Pa to about 4500 Pa, the range of about 3150 Pa to about 4000 Pa, the range of about 3250 Pa to about 7000 Pa, the range of about 3250 Pa to about 6000 Pa, the range of about 3250 Pa to about 5500 Pa, the range of about 3250 Pa to about 5000 Pa, the range of about 3250 Pa to about 4500 Pa, the range of about 3250 Pa to about 4000 Pa, the range of about 3400 Pa to about 7000 Pa, the range of about 3400 Pa to about 6000 Pa, the range of about 3400 Pa to about 5500 Pa, the range of about 3400 Pa to about 5000 Pa, the range of about 3400 Pa to about 4500 Pa, the range of about 3400 Pa to about 4000 Pa, the range of about 3500 Pa to about 7000 Pa, the range of about 3500 Pa to about 6000 Pa, the range of about 3500 Pa to about 5500 Pa, the range of about 3500 Pa to about 5000 Pa, the range of about 3500 Pa to about 4500 Pa, the range of about 3500 Pa to about 4000 Pa, the range of about 3600 Pa to about 7000 Pa, the range of about 3750 Pa to about 7000 Pa, the range of about 3250 Pa to about 5000 Pa, the range of about 3500 Pa to about 4500 Pa, or the range of about 3600 Pa to about 4000 Pa.

Complex viscosity and/or the elastic modulus may be measured using rheological thermal analysis. In some examples, a TA Instrument ARES-G2 Rheometer may be used to apply a sinusoidal shear strain to a 2 mm thick, 25 mm diameter disc of a sample while heating the sample at a rate of 5° C./minute from 0° C. to 80° C., and the resulting stress wave may be measured. The test geometry may be a 25 mm cross hatched parallel plate with a 500 mm cross hatched bottom peltier plate. The geometry gap may be equal to the sample thickness (e.g., 2 mm). The samples may be loaded at 30° C. The axial force may be 10 g±5 g, and the sampling rate may be 12 s/point. The complex viscosity and/or the elastic modulus as a function of temperature may be calculated from the stress-strain curve.

In another approach, the method of a making a plant-based cheese product includes adding a plant-based protein to water to form a first mixture. In some aspects, the first mixture may be mixed for an amount of time suitable to allow the plant-based protein to hydrate. The method also includes melting a fat component having a solid fat content in the range of about 50% to about 80% at 10° C. and about 15% to about 40% at 20° C. The method further includes adding the melted fat component, a stabilizer, and a thickening agent to the first mixture and mixing to form a second mixture. Other optional ingredients such as flavors or salt may be added to the second mixture at this point or later in the process. The ingredients are mixed in a mixer and, in some aspects, a mixer having direct steam injection capabilities. Steam is then injected directly into the second mixture to heat the second mixture. In some approaches, the second mixture is heated to a temperature within the range of about 150° F. to about 200° F., about 160° F. to about 200° F., about 160° F. to about 190° F., or in some aspects about 170° F. to about 190° F. In some aspects, the thickening agent may gelatinize before the second mixture is heated to such temperatures and heating may primarily be used to pasteurize the second mixture. In other aspects, heating may both pasteurize the second mixture and gelatinize the thickening agent.

In some aspects, the mixture of ingredients is heated to and held at a temperature effective to pasteurize the second mixture. In some approaches, the second mixture is heated via direct steam injection. In other approaches, the second mixture is heated via indirect steam injection (e.g., in a thermally jacketed vessel).

The second mixture is also homogenized to provide the plant-based cheese product in the form of a stable emulsion. The second mixture may be homogenized in using any suitable equipment capable of applying high shear to the mixture, for example, via a homogenizer or a shear pump. In some approaches, the second mixture is homogenized at an elevated pressure. In some aspects, the second mixture is homogenized to provide a homogenous mixture and to evenly distribute the ingredients. The heating by injecting steam may occur before homogenization.

In another aspect, any of the methods described herein may further comprise adding water to any of the mixtures described above, including either the first mixture or the second mixture. Water may be added to the mixture before or after (direct or indirect steam) heating. In one approach, water is added to provide a moisture % of the plant-based food product within the range of about 50% to about 80%, about 55% to about 75%, or about 60% to about 70%.

In another aspect, any of the methods described herein may further comprise adding an acidulant to any of the mixtures described above, including either the first mixture or the second mixture. The acidulant may be added to the mixture before or after (direct or indirect) steam heating. In one approach, the acidulant is added to provide a pH in the plant-based food product of about 3.5 to about 5.0, in another aspect about 3.8 to about 4.8, and in another aspect about 4.0 to about 4.4.

In another aspect, any of the methods described herein may further comprise adding one or more of salt, a preservative, a flavor, and a colorant.

The plant-based cheese products made by the methods described herein may be packaged into suitable consumer size containers. In some aspects, the plant-based cheese product is packaged into containers by “hot packing” procedures in which containers are filled at elevated temperatures (i.e., shortly after the pasteurization treatment and before the product has cooled to refrigeration temperatures). In some approaches, the plant-based cheese product is packaged into containers at a temperature within the range of about 145° F. to about 195° F., about 155° F. to about 195° F., about 155° F. to about 185° F., or in some aspects about 165° F. to about 185° F. In other aspects, the plant-based cheese product is packaged into containers by “cold packing” procedures in which containers are filled while the product is cold (i.e., at refrigeration temperatures).

To further illustrate the present disclosure, examples are given herein. It is to be understood that these examples are provided for illustrative purposes and are not to be construed as limiting the scope of the present disclosure.

### EXAMPLES

### Example 1

An example of the plant-based cream cheese product disclosed herein is prepared. The plant-based cream cheese product includes faba bean protein (VITESSENCE™ Pulse 3600 protein) as the plant-based protein, potato starch (ETENIA™ 457 starch) as the thickening agent, and a blend of coconut and sunflower oils (AKOVEG™ oil) as the fat component.

The plant-based cream cheese product may be prepared by adding water to a pre-heated mixer with steam injection capability (Breddo). Faba bean protein is first added to the water and mixed to allow the protein to hydrate. The coconut oil and sunflower oil blend is then melted. The coconut oil and sunflower oil blend has a solid fat content in the range of about 61% to about 67% at 10° C., and about 25% to about 29% at 20° C. The melted coconut oil and sunflower oil blend, citric acid, salt, a blend of xanthan gum, locust bean gum, and guar gum, potato starch, flavor, sorbic acid, and lactic acid are then added to the mixture of water and protein. The mixture is then heated to 180° F. via steam injection and recirculation. Once the temperature of the mixture reaches 170° F., additional flavors may be added. When the temperature of the mixture reaches 170° F., the pH and moisture % of the mixture are tested. Lactic acid is added as needed in an amount effective to provide a pH within the range of about 4.0 to about 4.4 in the final plant-based cheese product. Water is also added as needed to adjust the moisture % within the range of about 60% to about 70% in the final plant-based cheese product. The mixture is then heated to 180° F. and held at 180° F. for 1 minute for pasteurization. Then, the mixture is added to a homogenizer and mixed at 1000 psi for an amount of time sufficient to produce a homogenous mixture with a smooth texture. The heated mixture is then packaged into tubs and allowed to cool and is refrigerated. The final plant-based cream cheese product has an opaque, white color.

The general formulation of the plant-based cheese product is shown in Table 1, with the wt % of each ingredient that was used based on the total weight of the final plant-based cheese product.

TABLE 1

| | Plant-Based Cheese |
|---|---|
| | Product |
| Ingredient | (wt %) |
| Faba Bean Protein* | 1.25 |
| Coconut Oil & Sunflower oil blend** | 24.0 |
| Citric Acid | 0.035 |
| Water | 52.662 |
| Condensate | 13.0 |
| (Water added via condensation | |
| from steam injection) | |
| Salt | 1.2 |
| Xanthan Gum, Locust Bean Gum, | 0.5 |
| & Guar Gum Blend† | |
| Potato Starch†† | 6.65 |
| Sorbic Acid | 0.033 |
| Lactic Acid | 0.04 |
| Flavors | 0.63 |
| Total | 100.00 |
| Crude protein | 0.75% |
| pH | 4.0-4.4 |

*VITESSENCE ™ Pulse 3600 Protein
**AKOVEG ™ Oil (AAK USA Inc.)
†Stabilizer 424 (Ingredion)
††ETENIA ™ 457 Starch

### Example 2

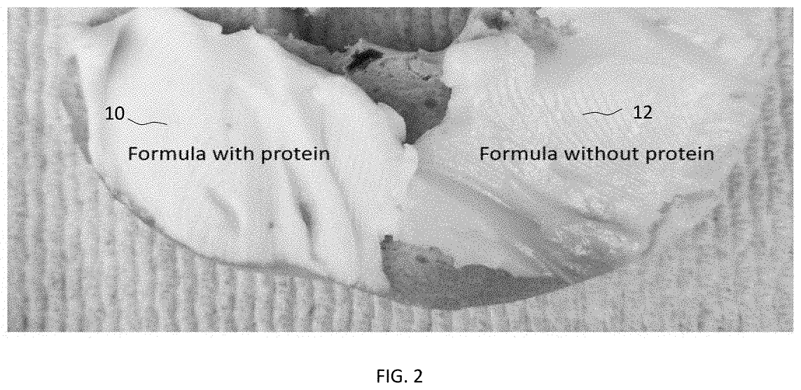

Two exemplary plant-based cream cheese products were prepared. The first plant-based cream cheese product was prepared using the formulation shown in Table 1 of Example 1. A comparative plant-based cream cheese product was prepared using the formulation shown in Table 2 below. The first plant-based cream cheese product was prepared with faba bean protein, and the comparative plant-based cheese product was prepared without protein and, instead, the protein was replaced with SHUR-FIL® starch (Tate & Lyle). Each plant-based cream cheese product had a soft, spreadable texture and was spread onto a freshly toasted bagel. The first plant-based cream cheese product retained its opacity while the comparative plant-based cream cheese product became translucent when spread onto the toasted bagel. FIG. 2 provides images comparing the first plant-based cream cheese product to the comparative plant-based cream cheese product on the bagel to illustrate the effect of protein on product appearance when spread on a substrate at elevated temperatures.

TABLE 2

| | Comparative Plant- |
|---|---|
| | Based Cheese Product |
| Ingredient | (wt %) |
| Coconut Oil & Sunflower oil blend** | 24.0 |
| Water | 52.3 |
| Condensate | 13.0 |
| (Water added via condensation | |
| from steam injection) | |
| Salt | 1.2 |
| Xanthan Gum, Locust Bean Gum, | 0.5 |
| & Guar Gum Blend† | |
| Potato Starch†† | 7.6 |
| Modified Starch‡ | 1.0 |
| Sorbic Acid | 0.03 |
| Flavors | 0.37 |
| Total | 100.00 |

**AKOVEG ™ Oil (AAK USA Inc.)
†Stabilizer 424 (Ingredion)
††ETENIA ™ 457 Starch
‡SHUR-FIL ® starch

### Example 3

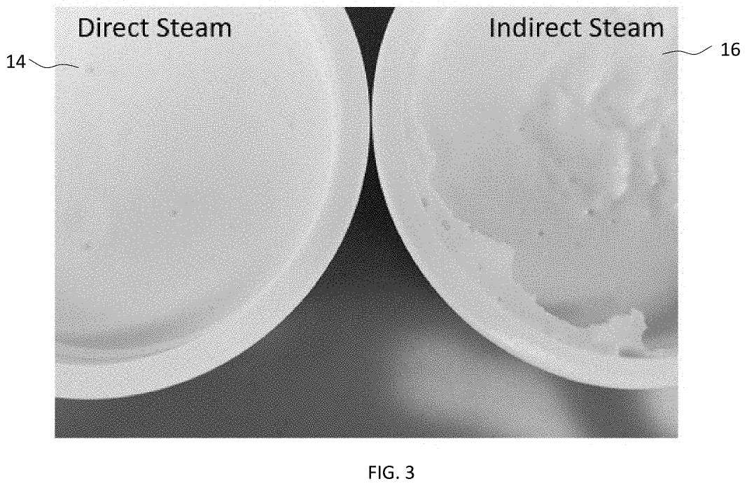

Two exemplary plant-based cheese products (Samples “A” and “B”) were prepared using the formulation shown in Table 3 below. The mixture used to prepare the plant-based cream cheese product “A” was heated via direct steam injection. By contrast, the mixture used to prepare the plant-based cream cheese product “B” was heated via indirect steam using a jacketed mixer. Sample “A” exhibited an off-white color and a shiny, wet appearance while Sample “B” exhibited some browning and a duller appearance than Sample “A”. FIG. 3 provides images comparing Sample “A” to Sample “B” to illustrate the impact of direct steam injection on product appearance. The texture and emulsion stability were substantially similar for both samples, but Sample B had a slightly off color (i.e., off-white color) and cooked, caramelized flavor notes.

TABLE 3

| | Plant-Based Cheese |
|---|---|
| | Product |
| Ingredient | (wt %) |
| Faba Bean Protein* | 5.0 |
| Coconut Oil & Sunflower oil blend** | 24.0 |
| Citric Acid | 0.03 |
| Malic Acid | 0.01 |
| Water | 48.38 |
| Condensate | 16.0 |
| (Water added via condensation | |
| from steam injection) | |
| Salt | 1.25 |
| Xanthan Gum, Locust Bean | 0.5 |
| Gum, & Guar Gum Blend† | |
| Potato Starch†† | 4.5 |
| Sorbic Acid | 0.03 |
| Lactic Acid | 0.3 |
| Total | 100.00 |

*VITESSENCE ™ Pulse 3600 Protein
**AKOVEG ™ Oil (AAK USA Inc.)
†Stabilizer 424 (Ingredion)
††ETENIA ™ 457 Starch

### Example 4

Two additional examples of the plant-based cheese product were prepared. Each of the example plant-based cheese products included faba bean protein (VITESSENCE™ Pulse 3600 protein) as the plant-based protein.

Two comparative examples of the plant-based cheese product were also prepared. The comparative example plant-based cheese products were prepared without protein; instead, the comparative example plant-based cheese products included a larger amount of starch than the example plant-based cheese products. As shown in Table 4 below, the comparative examples had a percent crude protein of 0.10 wt % or less, as it was found that the stabilizer and starch included low levels of protein.

Each of the samples (i.e., the example plant-based cheese products and comparative example plant-based cheese products) were prepared by blending and then homogenizing the ingredients at a pressure of 165 bar.

The general formulation of each of the samples is shown in Table 4, with the wt % of each ingredient that was used (based on the total weight of the plant-based cheese product). The percent fat, percent moisture, pH, percent crude protein, and percent salt of each of the samples is also shown in Table 4 (based on the total weight of the plant-based cheese product). The pH and percent crude protein were each determined via analytical testing. The percent crude protein may be determined via the Dumas Method or by the AOAC Official Method 992.15. In Table 4, the samples are referred to as “Comp. Ex. A,” “Comp. Ex. B,” “Ex. 0.5 wt % Faba,” and “Ex. 1 wt % Faba.”

TABLE 4

| | Comp. | Comp. | Ex. 0.5 wt | Ex. 1 wt |
|---|---|---|---|---|
| | Ex. A | Ex. B | % Faba | % Faba |
| Ingredient | (wt %) | (wt %) | (wt %) | (wt %) |
| Faba Bean Protein* | — | — | 0.500 | 1.000 |
| Coconut Oil & Sunflower | 24.000 | 24.000 | 24.000 | 24.000 |
| oil blend** | | | | |
| Citric Acid | — | — | 0.025 | 0.025 |
| Water | 65.847 | 65.847 | 66.055 | 66.055 |
| Salt | 1.400 | 1.400 | 1.400 | 1.400 |
| Xanthan Gum, Locust | 0.500 | 0.500 | 0.500 | 0.500 |
| Bean Gum, & Guar Gum | | | | |
| Blend† | | | | |
| Potato Starch†† | 8.170 | 7.170 | 7.462 | 6.962 |
| Modified Starch | — | 1.000 | — | — |
| Sorbic Acid | 0.033 | 0.033 | 0.033 | 0.033 |
| Lactic Acid | 0.050 | 0.050 | 0.025 | 0.025 |
| Total | 100.000 | 100.000 | 100.000 | 100.000 |
| PH | 3.99 | 3.93 | 4.44 | 4.72 |
| Crude Protein % | 0.10% | 0.06% | 0.38% | 0.64% |

*VITESSENCE ™ Pulse 3600 Protein
**AKOVEG ™ Oil (AAK USA Inc.)
†Stabilizer 424 (Ingredion)
††ETENIA ™ 457 Starch
‡SHUR-FIL ® starch

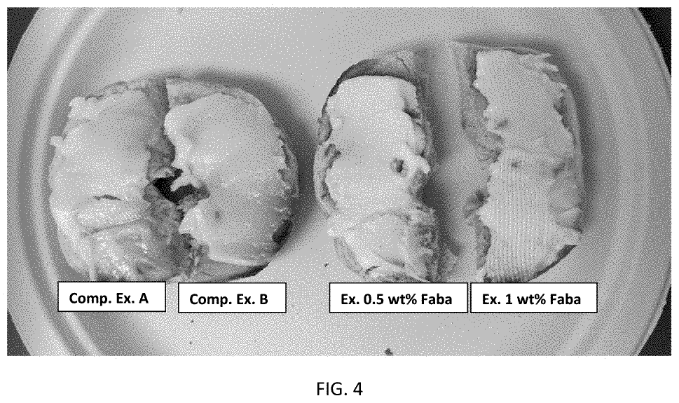

Each of the samples had a soft, spreadable texture and was spread onto a freshly toasted bagel. The Ex. 0.5 wt % Faba sample and the Ex. 1 wt % Faba sample retained their opacity while the Comp. Ex. A sample and the Comp. Ex. B sample became translucent and shiny when spread onto the toasted bagel. FIG. 4 provides images comparing the samples on the bagel to illustrate the effect of protein on product appearance when spread on a substrate at elevated temperatures.

Light Microscopy

Light microscopy (LM) images of each of the samples were taken. The LM images were taken with a Zeiss Imager.M2 light microscope equipped with an AxoCam MRc digital camera and operated by Zen 2.6 Blue software.

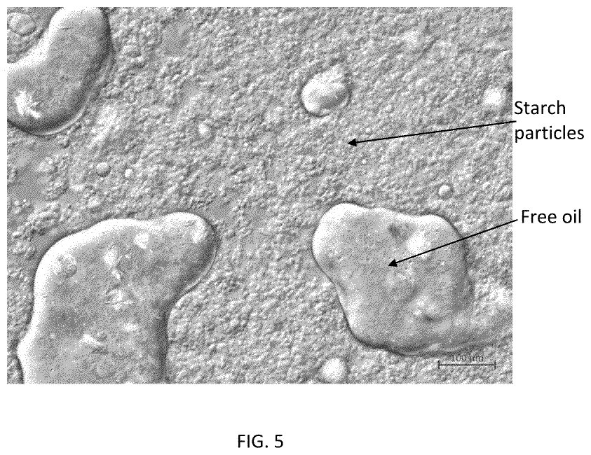

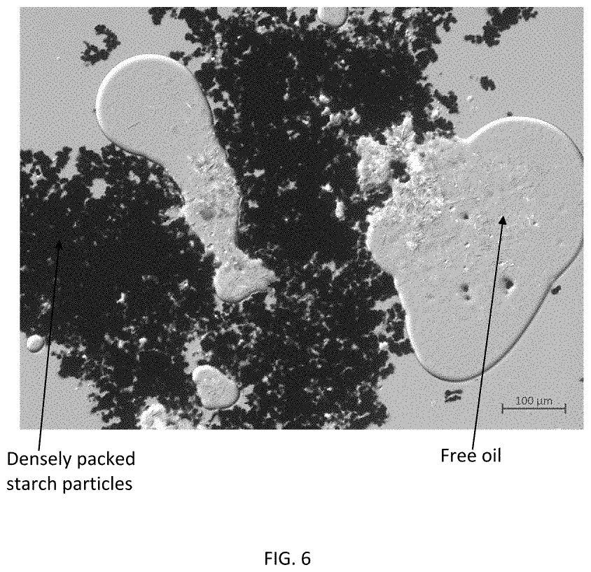

LM images of the Comp. Ex. A sample are shown in FIG. 5 and FIG. 6. FIG. 5 shows the Comp. Ex. A sample under differential interference contrast (DIC) optics of the light microscope. FIG. 6 shows the Comp. Ex. A sample stained with Lugol Iodine solution, a dye which stained the starch dark blue.

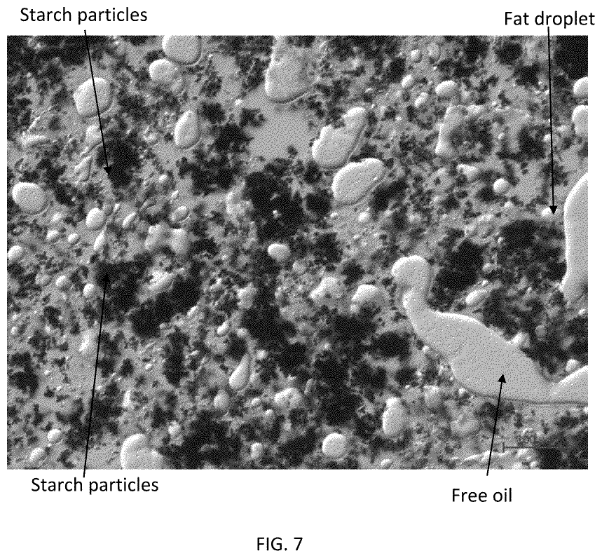

A LM image of the Comp. Ex. B sample is shown in FIG. 7. FIG. 7 shows the Comp. Ex. B sample stained with Lugol Iodine solution, which stained the starch dark blue.

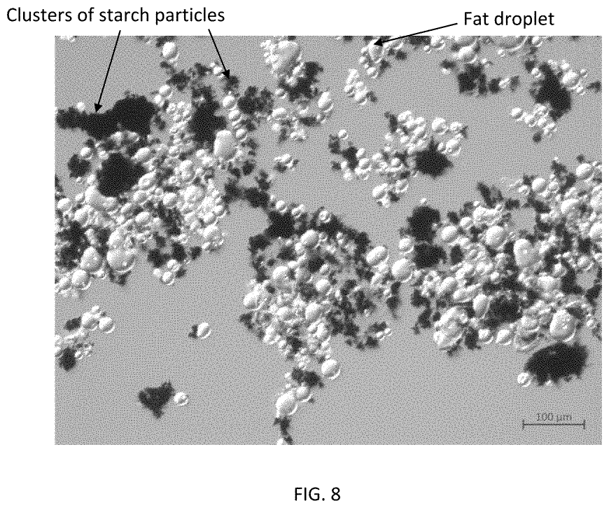

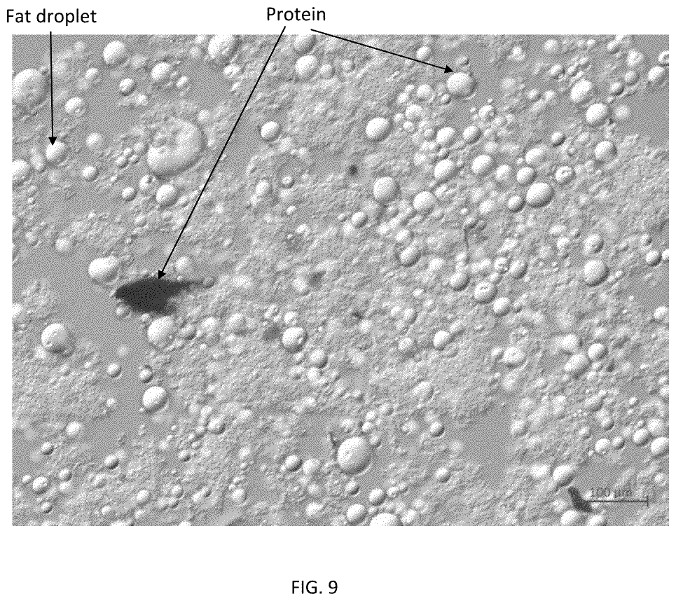

LM images of the Ex. 0.5 wt % Faba sample are shown in FIG. 8 and FIG. 9. FIG. 8 shows the Ex. 0.5 wt % Faba sample stained with Lugol Iodine solution, which stained the starch dark blue. FIG. 9 shows the Ex. 0.5 wt % Faba sample stained with Acid Fuchsin, a dye which stained the protein a pink color.

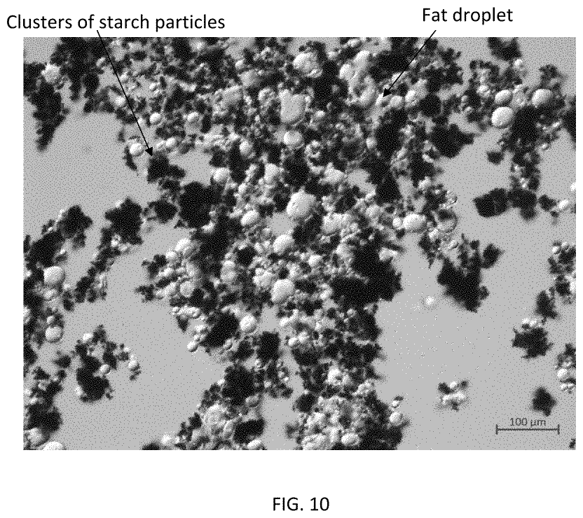

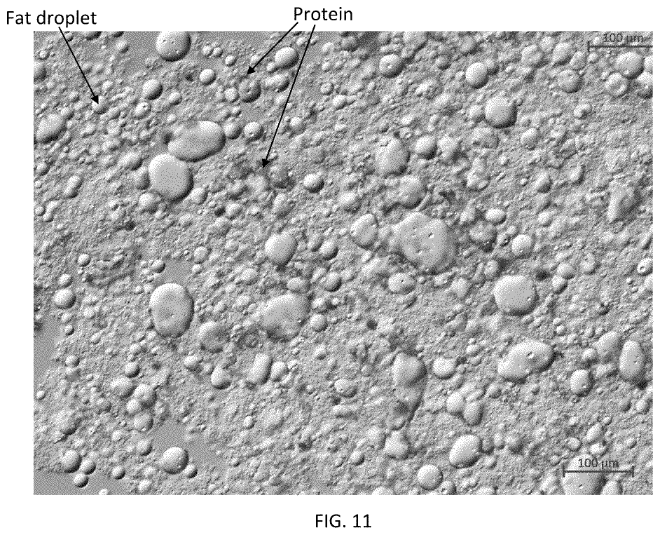

LM images of the Ex. 1 wt % Faba sample are shown in FIG. 10 and FIG. 11. FIG. 10 shows the Ex. 1 wt % Faba sample stained with Lugol Iodine solution, which stained the starch dark blue. FIG. 11 shows the Ex. 1 wt % Faba sample stained with Acid Fuchsin, which stained the protein a pink color.

As shown in FIG. 5 and FIG. 6, the fat component in the Comp. Ex. A sample was present as free oil separating from the starch particles, rather than forming individual oil droplets in a stable emulsion. As shown in FIG. 7, in the Comp. Ex. B sample, some of the fat component was present as free oil separating from the starch particles and some of the fat component was present as droplets. As shown in FIG. 5 through FIG. 7, while the starch acts as a thickener, it did not significantly contribute to emulsion stability. Thus, the larger fat droplets were able to coalesce to form the pockets of free oil in the Comp. Ex. A sample and the Comp. Ex. B sample.

As shown in FIG. 8 and FIG. 9, the fat component in the Ex. 0.5 wt % Faba sample was present as droplets, and as shown in FIG. 10 and FIG. 11, the fat component in the Ex. 0.5 wt % Faba sample was present as droplets. As shown in FIG. 8 through FIG. 11, the protein stabilized the emulsion by coating the surface of the fat droplets. Thus, smaller fat droplets and a more homogenous system were maintained in the Ex. 0.5 wt % Faba sample and the Ex. 1 wt % Faba sample.

Fat Droplet Size Distribution

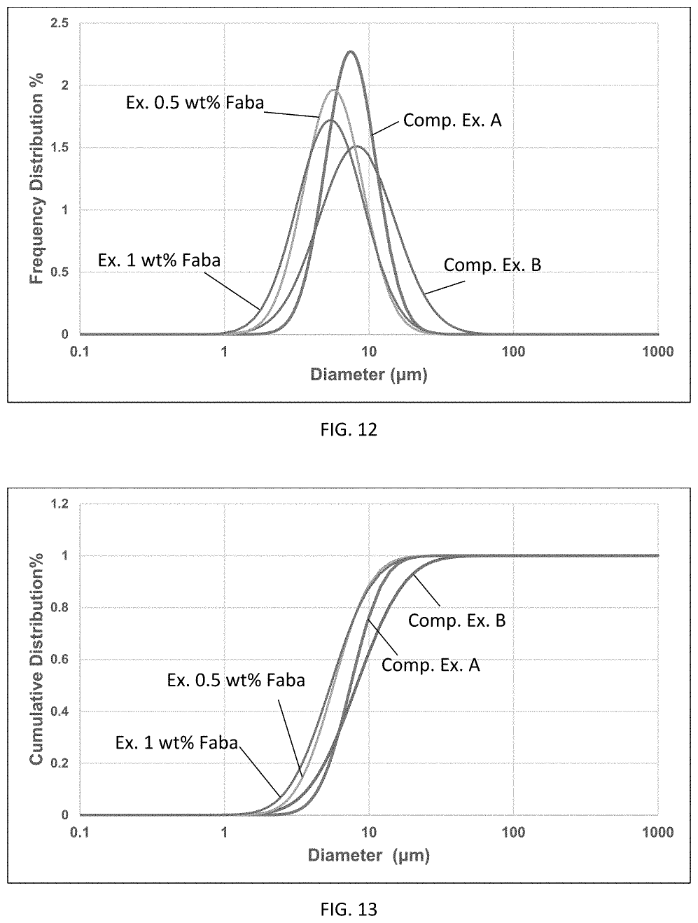

The fat droplet size distribution of each of the samples was measured at a temperature of 40° C. using a Bruker time-domain nuclear magnetic resonance droplet size analyzer (Bruker TD-NMR droplet size analyzer). A decay curve (intensity vs. time) of the NMR field was used to derive the fat droplet size distributions. The measurements were done in triplicates. The fat droplet size distribution of each of the samples is shown in FIG. 12 (frequency distribution percentage as a function of diameter (μm)) and FIG. 13 (cumulative distribution percentage as a function of diameter (μm)). The D2.5 (i.e., 2.5% of the fat droplets diameters are below this value), D50 (i.e., 50% of the fat droplets diameters are below this value), D97.5 (i.e., 97.5% of the fat droplets diameters are below this value), and width of distribution (i.e., the standard deviation

$$( \frac{D 97.5 - D 2.5}{4} )$$

of each of the samples are shown in Table 5.

TABLE 5

| | | | | Width of |
|---|---|---|---|---|
| | D2.5 | D50 | D97.5 | Distribution |
| Sample | (μm) | (μm) | (μm) | (μm) |
| Comp. Ex. A | 3.40 | 7.47 | 16.6 | 3.30 |
| Comp. Ex. B | 2.50 | 8.21 | 27.1 | 6.15 |
| Ex. 0.5 wt % Faba | 2.27 | 5.68 | 14.2 | 2.98 |
| Ex. 1 wt % Faba | 1.90 | 5.41 | 15.4 | 3.38 |

As shown in FIG. 12, FIG. 13, and in Table 5, the Ex. 0.5 wt % Faba sample and the Ex. 1 wt % Faba sample had smaller fat droplets than the Comp. Ex. A sample and the Comp. Ex. B sample. The Ex. 0.5 wt % Faba sample and the Ex. 1 wt % Faba sample also had narrow widths of distribution. It is believed that the samples containing faba bean protein had small fat droplets with narrow widths of distribution because they were stabilized better than the samples that did not contain plant-based protein.

Opacity

Light Intensity

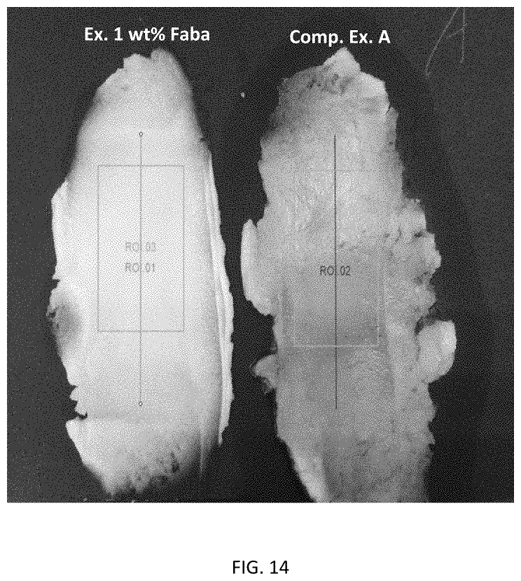

As shown in FIG. 14, each of the Ex. 1 wt % Faba sample and the Comp. Ex. A sample was spread onto a black substrate at room temperature (21° C.). The Ex. 1 wt % Faba sample was opaque while the Comp. Ex. A sample was translucent. The images illustrate the effect of protein on product appearance at room temperature.

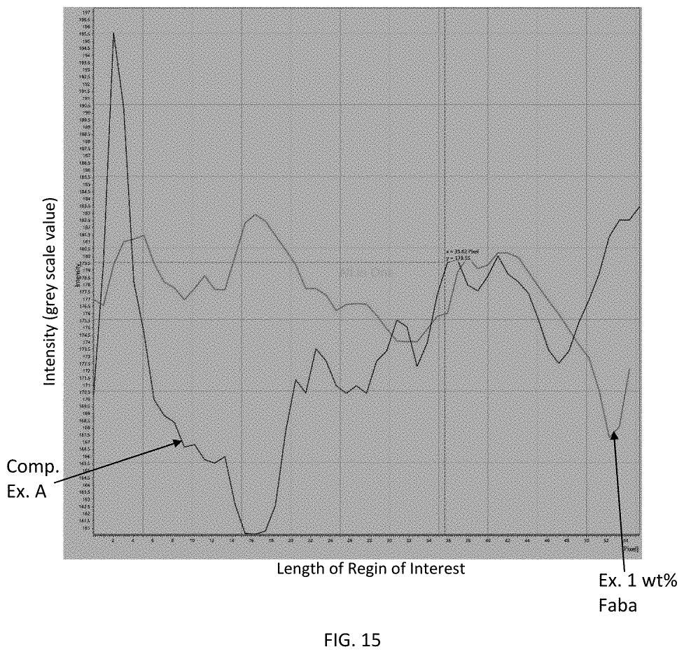

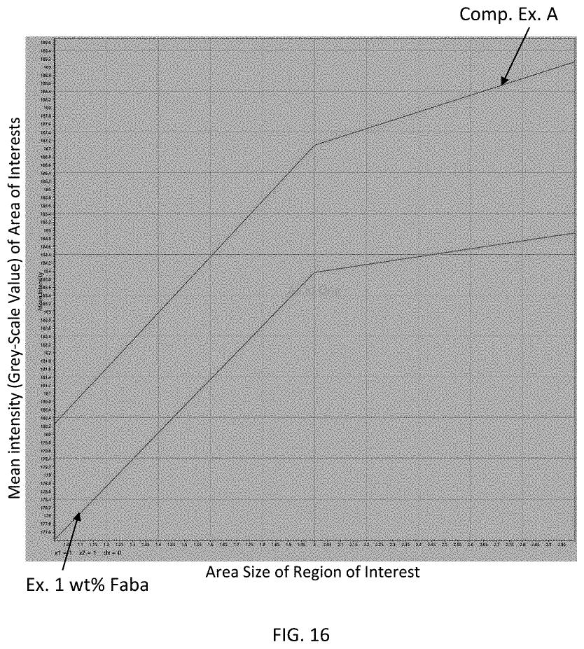

The light intensity and mean intensity of the Ex. 1 wt % Faba sample and the Comp. Ex. A sample on the black substrate were measured. The samples were analyzed using a Leica M205 C stereo-light microscope. The macrograph images (shown in FIG. 14) were captured by a Leica DMC4500 color digital camera and processed by Leica application software (LAS). The light intensity as a function of the position along the line shown in FIG. 14 of each of the samples is shown in FIG. 15. The mean intensity over the area in the box shown in FIG. 14 of each of the samples is shown in FIG. 16.

As shown in FIG. 15, the Comp. Ex. A sample had more variation in light intensity than the Ex. 1 wt % Faba sample. The Comp. Ex. A sample had high reflectance at certain line positions, indicating shininess, and low reflectance (i.e., light passed through easily) at certain positions, indicating translucence. In contrast, the Ex. 1 wt % Faba sample had a more even reflectance across positions, indicating opacity. As shown in FIG. 16, the Comp. Ex. A sample had a higher mean intensity than the Ex. 1 wt % Faba sample, indicating that the Comp. Ex. A sample was brighter and less opaque than the Ex. 1 wt % Faba sample.

Colorimetry

The colorimetry by reflectance of each of the samples was measured in the CIELAB color space. A HunterLab Aeros visual light spectrophotometer was used to measure the spectrum of visible light reflected from the surface of the sample in a tub held at room temperature (20° C.-25° C.). The intensity of reflected light was plotted as a function of wavelength (400-700 nm). The reflectance spectrum was then used to calculate the L* (Lightness) value, a* (green-red) value, and b* (blue-yellow) value of each of the samples. The L* (Lightness) value, a* (green-red) value, and b* (blue-yellow) value of each of the samples is shown in Table 6.

TABLE 6

| | Comp. | Comp. | Ex. 0.5 wt | Ex. 1 wt |
|---|---|---|---|---|
| | Ex. A | Ex. B | % Faba | % Faba |
| L* Value | 94.14 | 96.23 | 96.87 | 95.30 |
| a* Value | −0.64 | −0.54 | −0.57 | −0.58 |
| b* Value | 6.44 | 4.28 | 5.55 | 6.64 |

Light Transmission

To compare the samples at both room temperature and elevated temperature, the transmission of light with a wavelength of 865 nm through each of the samples (held in a 20 mm×10 mm×2 mm cuvette) was measured with a LUMISIZER® (LUM GmbH) at a position of 2 mm (path length for the light). The intensity of the light transmitted through the sample was measured as a function of time at various points along the length of the cuvette (20 mm). The average intensity of the light transmitted through sample was calculated by integrating the transmittance along the length of the cuvette. The average transmittance at the end of three minute was calculated for the samples. The measurements were done in duplicates at a temperature of 25° C. and 40° C. The average integral transmission (in percent for the last 3 minutes) of each of the samples is shown in Table 7.

TABLE 7

| | Average |
|---|---|
| | Transmission |
| Sample | (%) |
| Comp. Ex. A at | 16.3 |
| 25° C. | |
| Comp. Ex. B at | 12.3 |
| 25° C. | |
| Ex. 0.5 wt % Faba | 6.34 |
| at 25° C. | |
| Ex. 1 wt % Faba | 6.64 |
| at 25° C. | |
| Comp. Ex. A at | 21.9 |
| 40° C. | |
| Comp. Ex. B at | 15.6 |
| 40° C. | |
| Ex. 0.5 wt % Faba | 8.96 |
| at 40° C. | |
| Ex. 1 wt % Faba | 12.7 |
| at 40° C. | |

As shown in Table 7, the Ex. 0.5 wt % Faba sample and the Ex. 1 wt % Faba sample had less light transmission than the Comp. Ex. A sample and the Comp. Ex. B sample at each temperature. As such, the light transmission values indicate that the Ex. 0.5 wt % Faba sample and the Ex. 1 wt % Faba sample had higher opacity than the Comp. Ex. A sample and the Comp. Ex. B sample at both room temperature and elevated temperature.

Scattered Photon Count Rates

The scattered photon count rates (kcps) of each of the samples was measured at a temperature of 25° C., 40° C., and 60° C. To measure the scattered photon count rate, a Malvern Instruments Zeta Sizer Ultra dynamic light scattering instrument was used. A laser beam with a wavelength of 630 nm and a known photon count rate was sent through 2 mL of the sample in a cuvette, and the scattered light intensity was measured with the detector held at a 173-degree angle to the incident light beam. The intensity vs time curve was integrated for 2 minutes to get the average intensity of the scattered light. The derived mean count rates (kcps) of each of the samples is shown in Table 8.

TABLE 8

| | Derived | Derived | Derived |
|---|---|---|---|
| | Mean Count | Mean Count | Mean Count |
| | Rate (keps) at | Rate (keps) at | Rate (keps) at |
| Sample | 25° C. | 40° C. | 60° C. |
| Comp. Ex. A | 1.76E+06 | 3.40E+04 | 1.53E+06 |
| Comp. Ex. B | 4.59E+06 | 3.16E+04 | 2.17E+05 |
| Ex. 0.5 wt % Faba | 1.63E+07 | 1.99E+05 | 8.48E+04 |
| Ex. 1 wt % Faba | 8.42E+05 | 3.21E+04 | 8.69E+04 |

The extent of scattering is proportional to the number of particles and the size of particles in the sample. For the Ex. 0.5 wt % Faba sample and the Ex. 1 wt % Faba sample, the addition of protein decreased the size of the fat component droplets, which decreased the scattering by the fat component droplets. For the Ex. 0.5 wt % Faba sample and the Ex. 1 wt % Faba sample, the addition of protein also increased scattering due to the presence of the larger protein molecules. As such, the Ex. 0.5 wt % Faba sample and the Ex. 1 wt % Faba sample had derived mean count rates (kcps) at 25° C. and at 40° C. that were similar to the respective derived mean count rates of the Comp. Ex. A sample and the Comp. Ex. B sample.

At 60° C., the fat component melted and coalesced, and the addition of protein to the Ex. 0.5 wt % Faba sample and the Ex. 1 wt % Faba sample significantly reduced the scattered light intensity. As such, derived mean count rates (kcps) at 60° C. indicate that the Comp. Ex. A sample and the Comp. Ex. B sample will appear brighter at 60° C. than the Ex. 0.5 wt % Faba sample and the Ex. 1 wt % Faba sample.

Texture

Rheological Thermal Analysis

Rheological thermal analysis was performed on each of the samples using a TA Instruments ARES-G2 Rheometer. The rheological data indicated the relative firmness and textural attributes of the samples.

Using the TA Instrument ARES-G2 Rheometer, a sinusoidal shear strain was applied to a 2 mm thick, 25 mm diameter disc of a sample while heating the sample at a rate of 5° C./minute from 0° C. to 80° C., and the resulting stress wave was measured. The test geometry was a 25 mm cross hatched parallel plate with a 500 mm cross hatched bottom peltier plate. The geometry gap was equal to the sample thickness (i.e., 2 mm). The samples were loaded at 30° C. The axial force was 10 g±5 g, and the sampling rate was 12 s/point.

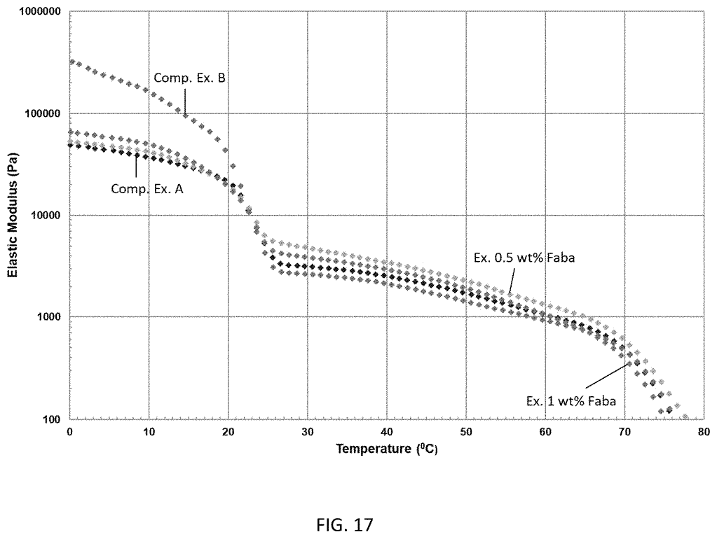

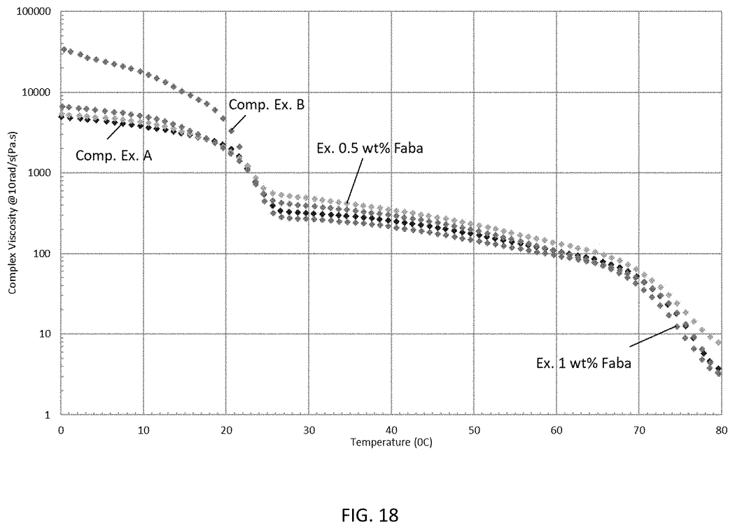

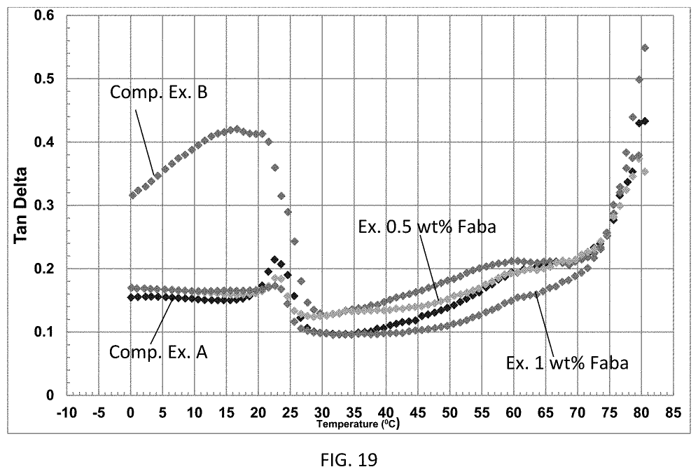

The complex viscosity, elastic modulus, loss modulus, and Tan δ (i.e. the quotient of the loss modulus (G″) and the elastic modulus (G′) (i.e., G″/G′)) as a function of temperature of each of the samples was calculated from the stress-strain curves. The tests were repeated until two overlaying curves of elastic modulus vs. temperature were obtained. The elastic modulus (Pa) as a function of temperature (° C.) of each of the samples is shown in FIG. 17. The complex viscosity at a frequency of 10 rad/s (Pa·s) as a function of temperature (° C.) of each of the samples is shown in FIG. 18, and the Tan δ as a function of temperature (° C.) of each of the samples is shown in FIG. 19. The elastic modulus (Pa), loss modulus (Pa), Tan δ, and complex viscosity (Pa·s, at a frequency of 10 rad/s) of each of the samples at a temperature of 5° C. (refrigerated temperature), 25° C. (room temperature), 37° C. (mouth temperature), and 80° C. (processing temperature) are shown in Table 9.

TABLE 9

| | Elastic | Loss | | Complex |
|---|---|---|---|---|
| | Modulus | Modulus | | Viscosity |
| Sample | (Pa) | (Pa) | Tan δ | (Pa · s) |
| Comp. Ex. A at | 43129 | 6693 | 0.155 | 4364 |
| 5° C. | | | | |
| Comp. Ex. B at | 223933 | 79988 | 0.357 | 23779 |
| 5° C. | | | | |
| Ex. 0.5 wt % Faba | 47428 | 7933 | 0.167 | 4809 |
| at 5° C. | | | | |
| Ex. 1 wt % Faba | 57784 | 9666 | 0.167 | 5859 |
| at 5° C. | | | | |
| Comp. Ex. A at | 3871 | 2527 | 0.157 | 392 |
| 25° C. | | | | |
| Comp. Ex. B at | 3097 | 1350 | 0.243 | 319 |
| 25° C. | | | | |
| Ex. 0.5 wt % Faba | 5594 | 4267 | 0.133 | 564 |
| at 25° C. | | | | |
| Ex. 1 wt % Faba | 4487 | 3909 | 0.116 | 452 |
| at 25° C. | | | | |
| Comp. Ex. A at | 2726 | 275 | 0.101 | 274 |
| 37° C. | | | | |
| Comp. Ex. B at | 2280 | 324 | 0.142 | 230 |
| 37° C. | | | | |
| Ex. 0.5 wt % Faba | 3750 | 502 | 0.134 | 378 |
| at 37° C. | | | | |
| Ex. 1 wt % Faba | 3190 | 308 | 0.096 | 320 |
| at 37° C. | | | | |
| Comp. Ex. A at | 34 | 15 | 0.430 | 4 |
| 80° C. | | | | |
| Comp. Ex. B at | 29 | 14 | 0.499 | 3 |
| 80° C. | | | | |
| Ex. 0.5 wt % Faba | 73 | 27 | 0.374 | 8 |
| at 80° C. | | | | |
| Ex. 1 wt % Faba | 31 | 12 | 0.379 | 3 |
| at 80° C. | | | | |

Because the samples are viscoelastic gels with elastic modulus values much greater than loss modulus values, the elastic modulus is approximately the same as firmness. As shown in FIG. 17 and Table 9, the Ex. 0.5 wt % Faba sample and the Ex. 1 wt % Faba sample had a higher elastic modulus, and thus were firmer, than the Comp. Ex. A sample and the Comp. Ex. B sample at temperatures within the range of 25° C. to 55° C.

As shown in FIG. 18 and Table 9, the Ex. 0.5 wt % Faba sample and the Ex. 1 wt % Faba sample had a higher complex viscosity than the Comp. Ex. A sample and the Comp. Ex. B sample at temperatures within the range of 25° C. to 55° C. Thus, FIG. 17, FIG. 18, and Table 9 indicate that the Ex. 0.5 wt % Faba sample and the Ex. 1 wt % Faba sample had a desirable dairy-like, spreadable texture sample at temperatures within the range of 25° C. to 55° C.

At temperatures below 25° C., the starch gelled and contributed to the firmness and viscosity of the samples. It is believed that at temperatures within the range of 25° C. to 55° C., as the starch gel melted, the emulsion stability provided by the protein in the Ex. 0.5 wt % Faba sample and the Ex. 1 wt % Faba sample resulted in those sample's increased firmness and viscosity (as compared to the Comp. Ex. A sample and the Comp. Ex. B sample). It is further believed that without the stabilizing effect of the protein, as the starch gel melted, the fat droplets in the Comp. Ex. A sample and the Comp. Ex. B sample moved and coalesced resulting in the faster softening of those samples (as compared to the Ex. 0.5 wt % Faba sample and the Ex. 1 wt % Faba sample).

### Example 5

An additional example of the plant-based cheese product was prepared. The general formulation of this example is shown in Table 10, with the wt % of each ingredient that was used (based on the total weight of the plant-based cheese product). The plant-based cheese product had a desirable dairy-like white color and maintained its opacity when applied to a toasted bread slice or bagel.

TABLE 10

| | Plant-Based Cheese |
|---|---|
| | Product |
| Ingredient | (wt %) |
| Water | 66.70 |
| Coconut Oil | 22.25 |
| Potato Starch†† | 5.14 |
| Salt | 1.50 |
| Xanthan Gum, Locust Bean | 0.50 |
| Gum, & Guar Gum Blend† | |
| Faba Bean Protein* | 2.55 |
| Flavors | 1.15 |
| Sorbic Acid | 0.05 |
| Citric Acid | 0.04 |
| Lactic Acid | 0.12 |
| Total | 100.00 |
| PH | pH 4-4.4 |
| | (target range) |
| Crude protein | 1.53% (from faba bean) |
| | plus 0.1% from starch |
| | and gum blend |
| | (Calculated) |

* VITESSENCE ™ Pulse 3600 Protein
†Stabilizer 424 (Ingredion)
††ETENIA ™ 457 Starch

### Example 6

A simplified model cream cheese system was prepared to compare the effect of protein on resulting cream cheese products. The cream cheese products did not include starch-based thickening agents. Thirteen examples of plant-based cream cheese product were prepared. To prepare each of the examples, an initial mixture of protein, glucose, fat component and water was prepared. Then, a lactic acid culture, salt, and stabilizer were added, and the samples were fermented at 40° C. for about 18 hours in order to reach a pH of less than 4.6. The cultures were commercially available cultures obtained from CHR Hansen. After fermentation, each sample was pasteurized in a water bath while mixed by hand.

The general formulation of the initial and final mixtures for each of the examples is shown in Table 11. The general formulation of the examples is shown in Table 11, with the wt % of each ingredient that was used (based on the total weight of the initial mixture).

TABLE 11

| | Initial Mixture |
|---|---|
| Ingredient | (wt %) |
| Plant-Based Protein | 3.0 |
| Glucose | 2.0 |
| Fat Component (Coconut Oil) | 24.0 |
| Water | 71.0 |
| Total | 100.00 |
| Ingredient | Plant-Based Cream |
| | Cheese Product |
| | (parts) |
| Initial Mixture | 100.0 |
| Culture | 0.02 |
| Salt | 1.0 |
| Stabilizer (Locust Bean Gum) | 0.4 |

*Culture dosing was 0.02 wt % for the starter culture and 0.01 wt % for each adjunct flavor culture.

Each of the examples included coconut oil as the fat component and locust bean gum as the stabilizer. The plant-based protein and culture included in each of the examples are shown in Table 12.

TABLE 12

| | Plant-Based | |
|---|---|---|
| Sample | Protein | Culture |
| Ex. 1 | Soy “A” | Yogurt Culture “A” |
| Ex. 2 | Soy “A” | Yogurt Culture “B” |
| Ex. 3 | Lentil | Yogurt Culture “A” |
| Ex. 4 | Lentil | Yogurt Culture “B” |
| Ex. 5 | Chickpea | Yogurt Culture “B” |
| Ex. 6 | Faba Bean “A” | Yogurt Culture “B” |
| Ex. 7 | Faba Bean “B” | Yogurt Culture “A” |
| Ex. 8 | Faba Bean “B” | Yogurt Culture “B” |
| Ex. 9 | Potato | Yogurt Culture “B” |
| Ex. 10 | Pea | Yogurt Culture “A” |
| Ex. 11 | Pea | Yogurt Culture “B” |
| Ex. 12 | Soy “B” | Yogurt Culture “A” |
| Ex. 13 | Soy “B” | Yogurt Culture “A” |
| | | & Semi-Hard |
| | | Cheese Culture* |

*Ex. 13 was treated with citric acid to a fermentation start pH of 6.0.

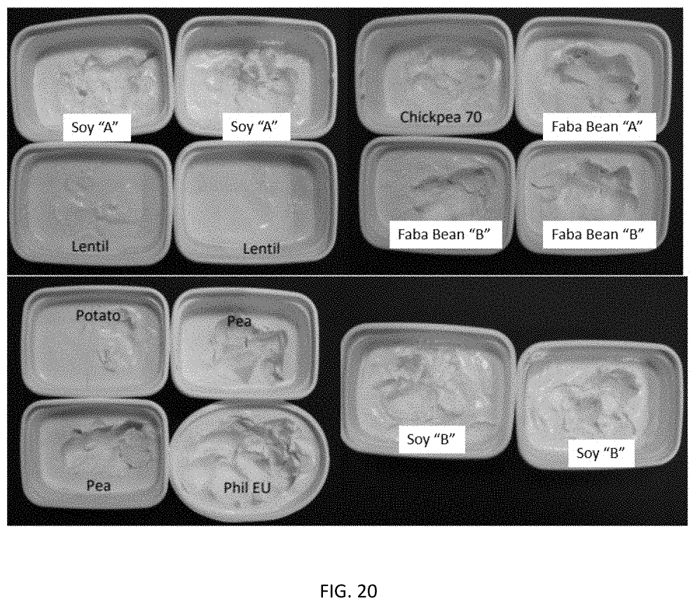

Each of the examples was filled into a container. FIG. 20 provides images comparing each of the examples and European Union (EU) Philadelphia® cream cheese (referred to herein as “Phil EU”). In FIG. 20, the examples are identified by the plant-based protein they contain. As shown in FIG. 20, Ex. 1, Ex. 2, Ex. 5, Ex. 6, Ex. 7, Ex. 8, Ex. 12, and Ex. 13 had a desirable off-white color.

The colorimetry by reflectance of each of the examples in the containers, Phil EU, United States (USA) Philadelphia® cream cheese (referred to herein as “Phil USA”) was measured. The colorimetry by reflectance was measured in the CIELAB color space. A comparable colorimetry analytical technique to that described above in Example 4 was used here.

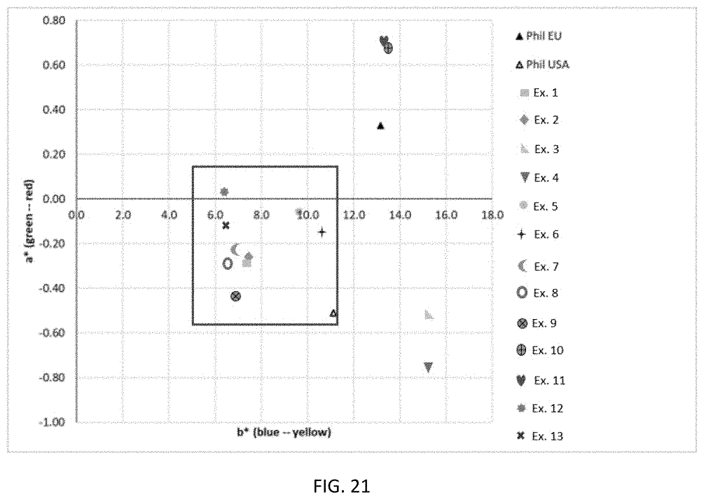

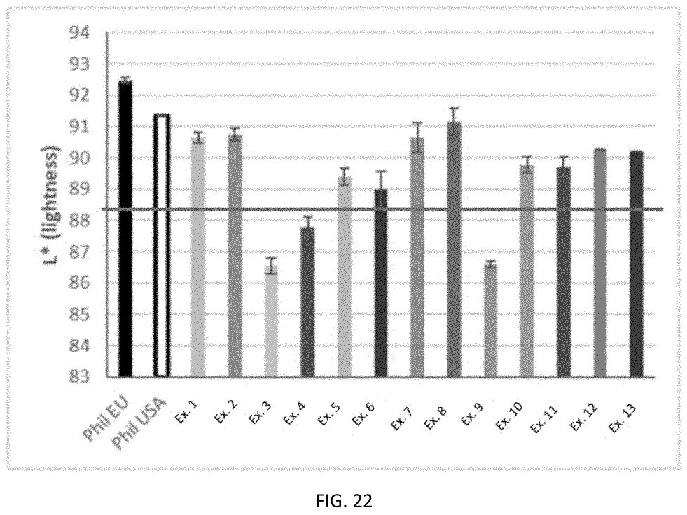

The a* (green-red) value and b* (blue-yellow) value of each of the samples is shown in FIG. 21. The box in FIG. 21 indicates desirable a* value and b* value combinations. The L* (Lightness) value of each of the samples is shown in FIG. 22. L* values above the horizontal line in FIG. 22 desirable are desirable.

As shown in FIG. 21 and FIG. 22, Ex. 1, Ex. 2, Ex. 5, Ex. 6, Ex. 7, Ex. 8, Ex. 12, and Ex. 13 had desirable a*, b*, and L* values. As also shown in FIG. 22, Ex 8 had a L* value closest to the L* value of Phil USA. As such, FIG. 20 through FIG. 22 indicate that soy, chickpea, and faba bean protein produce plant-based cream cheese products with desirable color.

To further illustrate the present disclosure, aspects are given herein. It is to be understood that these aspects are provided for illustrative purposes and are not to be construed as limiting the scope of the present disclosure.

### Aspects

In a first aspect, the present disclosure pertains to a plant-based cheese product comprising: a plant-based protein; a stabilizer; a thickening agent; and a fat component having a solid fat content within the range of about 50% to about 80% at 10° C. and about 15% to about 40% at 20° C.

In a second aspect, the present disclosure pertains to the plant-based cheese product of the first aspect, further comprising an acidulent in an amount effective to provide a pH in the plant-based cheese product of about 3.5 to about 5.0.

In a third aspect, the present disclosure pertains to the plant-based cheese product of the first aspect or the second aspect, further comprising water in an amount effective to provide a moisture % of the plant-based cheese product of about 50% to about 80%.

In a fourth aspect, the present disclosure pertains to the plant-based cheese product of any one of the first aspect to the third aspect, wherein the plant-based protein comprises one or more of faba bean protein, pea protein, and soy protein.

In a fifth aspect, the present disclosure pertains to the plant-based cheese product of any one of the first aspect to the fourth aspect, wherein the fat component comprises coconut oil and sunflower oil.

In a sixth aspect, the present disclosure pertains to the plant-based cheese product of any one of the first aspect to the fifth aspect, wherein the thickening agent comprises a starch.

In a seventh aspect, the present disclosure pertains to the plant-based cheese product of the sixth aspect, wherein the starch is an enzymatically converted potato starch.

In an eighth aspect, the present disclosure pertains to the plant-based cheese product of any one of the first aspect to the seventh aspect, wherein the stabilizer comprises at least one hydrocolloid.

In a ninth aspect, the present disclosure pertains to the plant-based cheese product of the eighth aspect, wherein the at least one hydrocolloid comprises one or more of inulin, pectin, carboxymethylcellulose, carrageenan, gum arabic, xanthan gum, locust bean gum, and guar gum.

In a tenth aspect, the present disclosure pertains to the plant-based cheese product of the eighth aspect, wherein the at least one hydrocolloid comprises a combination of xanthan gum, locust bean gum, and guar gum.

In an eleventh aspect, the present disclosure pertains to the plant-based cheese product of the eighth aspect, wherein the at least one hydrocolloid comprises locust bean gum.

In a twelfth aspect, the present disclosure pertains to the plant-based cheese product of any one of the first aspect to the eleventh aspect, wherein the plant-based cheese product is in the form of a cream cheese product.

In a thirteenth aspect, the present disclosure pertains to the plant-based cheese product of any one of the first aspect to the twelfth aspect, wherein the plant-based cheese includes no animal-derived proteins.

In a fourteenth aspect, the present disclosure pertains to the plant-based cheese product of any one of the first aspect to the thirteenth aspect, wherein the plant-based protein is present in an amount within the range of about 0.01 wt % to about 15 wt % crude protein, based on a total weight of the plant-based cheese product.

In a fifteenth aspect, the present disclosure pertains to the plant-based cheese product of any one of the first aspect to the fourteenth aspect, wherein the stabilizer is present in an amount within the range of about 0.01 wt % to about 5 wt %, based on a total weight of the plant-based cheese product; and the thickening agent is present in an amount within the range of about 1 wt % to about 25 wt %, based on a total weight of the plant-based cheese product.

In a sixteenth aspect, the present disclosure pertains to the plant-based cheese product of any one of the first aspect to the fifteenth aspect, wherein the fat component is present in an amount within the range of about 15 wt % to about 35 wt %, based on a total weight of the plant-based cheese product.

In a seventeenth aspect, the present disclosure pertains to a method of making a plant-based cheese product, comprising: mixing water, a plant-based protein, a thickening agent, a stabilizer, and a fat component to form a mixture, the fat component having a solid fat content within the range of about of about 50% to about 80% at 10° C. and about 15% to about 40% at 20° C.; heating the mixture to a temperature within the range of about 150° F. to about 200° F. via direct steam injection; and homogenizing the heated mixture to form the plant-based cheese product, wherein the heating by injecting steam may occur before or during the homogenizing.

In an eighteenth aspect, the present disclosure pertains to the method of the seventeenth aspect, further comprising filling the plant-based cheese product into a container.

In a nineteenth aspect, the present disclosure pertains to the method of the seventeenth aspect or the eighteenth aspect, wherein the mixture is heated via direct steam injection to a temperature within the range of about 150° F. to about 200° F. for about 1 second to about 5 minutes.

In a twentieth aspect, the present disclosure pertains to the method of any one of the seventeenth aspect to the nineteenth aspect, further comprising adding an acidulent to the mixture to provide a pH within the range of about 3.5 to 5.0 in the plant-based cheese product.

In a twenty-first aspect, the present disclosure pertains to the method of any one of the seventeenth aspect to the twentieth aspect, further comprising adding at least one flavor to the mixture.

In a twenty-second aspect, the present disclosure pertains to the method of any one of the seventeenth aspect to the twenty-first aspect, wherein water is added to the mixture in an amount to provide a moisture % within the range of about 50% to about 80% in the plant-based cheese product.

In a twenty-third aspect, the present disclosure pertains to the method of any one of the seventeenth aspect to the twenty-second aspect, wherein the plant-based protein is present in an amount within the range of about 0.01 wt % to about 15 wt % crude protein, based on a total weight of the plant-based cheese product; the stabilizer is present in an amount within the range of about 0.01 wt % to about 5 wt %, based on the total weight of the plant-based cheese product; the thickening agent is present in an amount within the range of about 1 wt % to about 25 wt %, based on the total weight of the plant-based cheese product; and the fat component is present in an amount within the range of about 15 wt % to about 35 wt %, based on the total weight of the plant-based cheese product.

In a twenty-fourth aspect, the present disclosure pertains to a method of making a plant-based cheese product, comprising: adding a plant-based protein to water to form a first mixture; melting a fat component having a solid fat content within the range of about 50% to about 80% at 10° C. and about 15% to about 40% at 20° C.; adding the melted fat component, a stabilizer, and a thickening agent to the first mixture and mixing to form a second mixture; injecting steam directly into the second mixture to pasteurize the second mixture; and homogenizing the second mixture to form the plant-based cheese product, wherein the heating by injecting steam may occur before or during the homogenizing.

In a twenty-fifth aspect, the present disclosure pertains to the method of the twenty-fourth aspect, further comprising adding an acidulent to the second mixture an amount effective to provide a pH within the range of about 3.5 to about 5.0 in the plant-based cheese product.

In a twenty-sixth aspect, the present disclosure pertains to the method of the twenty-fourth aspect or the twenty-fifth aspect, wherein the plant-based cheese product is in the form of a cream cheese product.

In a twenty-seventh aspect, the present disclosure pertains to the method of any one of the twenty-fourth aspect to the twenty-sixth aspect, wherein the plant-based cheese product includes no animal-derived proteins.

In a twenty-eighth aspect, the present disclosure pertains to the method of any one of the twenty-fourth aspect to the twenty-seventh aspect, wherein the plant-based protein is present in an amount within the range of about 0.01 wt % to about 15 wt % crude protein, based on a total weight of the plant-based cheese product; the stabilizer is present in an amount within the range of about 0.01 wt % to about 5 wt %, based on the total weight of the plant-based cheese product; the thickening agent is present in an amount within the range of about 1 wt % to about 25 wt %, based on the total weight of the plant-based cheese product; and the fat component is present in an amount within the range of about 15 wt % to about 35 wt %, based on the total weight of the plant-based cheese product.

Additionally, or alternatively, the present disclosure may pertain to the following aspects.

In a first aspect, the present disclosure pertains to a plant-based cream cheese product in the form of a homogenous mixture comprising: about 0.2 wt % to about 8 wt % plant-based crude protein, by weight of the plant-based cream cheese product; about 0.01 wt % to about 5 wt % stabilizer; about 1 wt % to about 12 wt % starch-based thickening agent; and about 10 wt % to about 50 wt % fat component, wherein the fat component of the plant-based cream cheese product is in the form of oil droplets with a D50 value at 40° C. within the range of about 1.5 μm to about 7 μm.

In a second aspect, the present disclosure pertains to the plant-based cream cheese product of the first aspect, wherein the fat component of the plant-based cream cheese product is in the form of oil droplets with a D50 value at 40° C. within the range of about 1.5 μm to about 6.75 μm.

In a third aspect, the present disclosure pertains to the plant-based cream cheese product of the first aspect or the second aspect, wherein the fat component of the plant-based cream cheese product is in the form of oil droplets with a width of distribution of 5.0 μm or less.

In a fourth aspect, the present disclosure pertains to the plant-based cream cheese product of any one of the first aspect to the third aspect, wherein the fat component of the plant-based cream cheese product is in the form of oil droplets with a width of distribution of 4.0 μm or less.

In a fifth aspect, the present disclosure pertains to the plant-based cream cheese product of any one of the first aspect to the fourth aspect, wherein the plant-based cheese product has a complex viscosity at a frequency of 10 rad/s and a temperature of 25° C. within the range of about 400 Pa·s to about 1200 Pa·s.

In a sixth aspect, the present disclosure pertains to the plant-based cream cheese product of any one of the first aspect to the fifth aspect, wherein the plant-based cheese product has a complex viscosity at a frequency of 10 rad/s and a temperature of 25° C. within the range of about 400 Pa·s to about 1150 Pa·s.

In a seventh aspect, the present disclosure pertains to the plant-based cream cheese product of any one of the first aspect to the sixth aspect, wherein the plant-based cheese product has a complex viscosity at a frequency of 10 rad/s and a temperature of 37° C. within the range of about 300 Pa·s to about 1000 Pa·s.

In an eighth aspect, the present disclosure pertains to the plant-based cream cheese product of any one of the first aspect to the seventh aspect, wherein the plant-based cheese product has a complex viscosity at a frequency of 10 rad/s and a temperature of 37° C. within the range of about 300 Pa·s to about 750 Pa·s.

In a ninth aspect, the present disclosure pertains to the plant-based cream cheese product of any one of the first aspect to the eighth aspect, wherein the plant-based cheese product has an elastic modulus at a temperature of 25° C. within the range of about 4000 Pa to about 8000 Pa.

In a tenth aspect, the present disclosure pertains to the plant-based cream cheese product of any one of the first aspect to the ninth aspect, wherein the plant-based cheese product has an elastic modulus at a temperature of 25° C. within the range of about 4000 Pa to about 7500 Pa.

In an eleventh aspect, the present disclosure pertains to the plant-based cream cheese product of any one of the first aspect to the tenth aspect, wherein the plant-based cheese product has an elastic modulus at a temperature of 37° C. within the range of about 3000 Pa to about 7000 Pa.

In a twelfth aspect, the present disclosure pertains to the plant-based cream cheese product of any one of the first aspect to the eleventh aspect, wherein the plant-based cheese product has an elastic modulus at a temperature of 37° C. within the range of about 3000 Pa to about 6000 Pa.

In a thirteenth aspect, the present disclosure pertains to the plant-based cream cheese product of any one of the first aspect to the twelfth aspect, wherein the fat component has a solid fat content within the range of about 50% to about 90% at 10° C. and about 15% to about 45% at 20° C.

In a fourteenth aspect, the present disclosure pertains to the plant-based cream cheese product of any one of the first aspect to the thirteenth aspect, wherein the starch-based thickening agent is a shear tolerant starch.

In a fifteenth aspect, the present disclosure pertains to the plant-based cream cheese product of any one of the first aspect to the fourteenth aspect, wherein the plant-based crude protein comprises one or more of faba bean protein, pea protein, and soy protein.

In a sixteenth aspect, the present disclosure pertains to the plant-based cream cheese product of any one of the first aspect to the fifteenth aspect, wherein the plant-based crude protein is faba bean protein.

In a seventeenth aspect, the present disclosure pertains to the plant-based cream cheese product of any one of the first aspect to the sixteenth aspect, wherein the fat component comprises one or more of coconut oil and sunflower oil.

In an eighteenth aspect, the present disclosure pertains to the plant-based cream cheese product of any one of the first aspect to the seventeenth aspect, wherein the fat component comprises coconut oil.

In a nineteenth aspect, the present disclosure pertains to the plant-based cream cheese product of any one of the first aspect to the eighteenth aspect, wherein the stabilizer comprises at least one hydrocolloid.

In a twentieth aspect, the present disclosure pertains to the plant-based cream cheese product of any one of the first aspect to the nineteenth aspect, wherein the at least one hydrocolloid comprises one or more of inulin, pectin, carboxymethylcellulose, carrageenan, gum arabic, xanthan gum, locust bean gum, and guar gum.

In a twenty-first aspect, the present disclosure pertains to the plant-based cream cheese product of any one of the first aspect to the twentieth aspect, wherein the at least one hydrocolloid comprises a combination of xanthan gum, locust bean gum, and guar gum.

In a twenty-second aspect, the present disclosure pertains to the plant-based cream cheese product of any one of the first aspect to the twenty-first aspect, wherein the at least one hydrocolloid comprises locust bean gum.

In a twenty-third aspect, the present disclosure pertains to the plant-based cream cheese product of any one of the first aspect to the twenty-second aspect, wherein the stabilizer is present in an amount within the range of about 0.01 wt % to about 1 wt %, based on a total weight of the plant-based cream cheese product; and the starch-based thickening agent is present in an amount within the range of about 3 wt % to about 10 wt %, based on a total weight of the plant-based cream cheese product.

In a twenty-fourth aspect, the present disclosure pertains to the plant-based cream cheese product of any one of the first aspect to the twenty-third aspect, wherein the fat component is present in an amount within the range of about 15 wt % to about 35 wt %, based on a total weight of the plant-based cream cheese product.

In a twenty-fifth aspect, the present disclosure pertains to a making the plant-based cream cheese product according to any one of the first aspect to the twenty-fourth aspect, comprising: mixing water, a plant-based crude protein, a starch-based thickening agent, a stabilizer, and a fat component to form a mixture; heating the mixture to a temperature within the range of about 150° F. to about 200° F.; and homogenizing the heated mixture to form the plant-based cream cheese product.

In a twenty-sixth aspect, the present disclosure pertains to the method of the twenty-fifth aspect, further comprising filling the plant-based cream cheese product into a container and cooling the plant-based cream cheese product to refrigeration temperature.

In a twenty-seventh aspect, the present disclosure pertains to the method of the twenty-fifth aspect or the twenty-sixth aspect, wherein the mixture is heated via direct steam injection to a temperature within the range of about 150° F. to about 200° F. for about 1 second to about 5 minutes.

In a twenty-eighth aspect, the present disclosure pertains to the method of any one of the twenty-fifth aspect to the twenty-seventh aspect, further comprising adding an acidulant to the mixture to provide a pH within the range of about 3.5 to 5.0 in the plant-based cream cheese product.

In a twenty-ninth aspect, the present disclosure pertains to the method of any one of the twenty-fifth aspect to the twenty-eighth aspect, wherein water is added to the mixture in an amount to provide a moisture % within the range of about 50% to about 80% in the plant-based cream cheese product.

In a thirtieth aspect, the present disclosure pertains to a method of making the plant-based cream cheese product according to any one of the first aspect to the twenty-fourth aspect, comprising: adding a plant-based protein to water to form a first mixture; melting a fat component having a solid fat content within the range of about 50% to about 90% at 10° C. and about 15% to about 45% at 20° C.; adding the melted fat component, a stabilizer, and a starch-based thickening agent to the first mixture and mixing to form a second mixture; heating the second mixture to pasteurize the second mixture; and homogenizing the second mixture to form the plant-based cream cheese product.

In a thirty-first aspect, the present disclosure pertains to the method of the thirtieth aspect, further comprising filling the plant-based cream cheese product into a container and cooling the plant-based cream cheese product to refrigeration temperature.

In a thirty-second aspect, the present disclosure pertains to the method of the thirtieth aspect or the thirty-first aspect, wherein heating of the second mixture is by direct steam injection to a temperature within the range of about 150° F. to about 200° F. for about 1 second to about 5 minutes.

In a thirty-third aspect, the present disclosure pertains to the method of any one of the thirtieth aspect to the thirty-second aspect, further comprising adding an acidulant to the first or second mixture to provide a pH within the range of about 3.5 to 5.0 in the plant-based cream cheese product.

In a thirty-fourth aspect, the present disclosure pertains to the method of any one of the thirtieth aspect to the thirty-third aspect, wherein water is included in an amount to provide a moisture % within the range of about 50% to about 80% in the plant-based cream cheese product.

It is to be understood that the ranges provided herein include the stated range and any value or sub-range within the stated range. For example, a range of about 5 wt % to about 15 wt % should be interpreted to include not only the explicitly recited limits of range of about 5 wt % to about 15 wt %, but also to include individual values, such as 6.35 wt %, 7.5 wt %, 10 wt %, 12.75 wt %, 14 wt %, etc., and sub-ranges, such as about 7 wt % to about 10.5 wt %, about 8.5 wt % to about 12.7 wt %, about 9.75 wt % to about 14 wt %, etc. Furthermore, when “about” is utilized to describe a value, this is meant to encompass minor variations (up to +/−10%) from the stated value.

All percentages and ratios are calculated by weight unless otherwise indicated. All percentages and ratios are calculated based on the total weight of the compound or composition unless otherwise indicated.

Reference throughout the specification to “an example,” “one example,” “another example,” “some examples,” “other examples,” and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A plant-based cream cheese product in the form of a homogenous mixture comprising:
about 0.2 wt % to about 8 wt % plant-based crude protein, by weight of the plant-based cream cheese product;
about 0.01 wt % to about 5 wt % stabilizer;
about 1 wt % to about 12 wt % starch-based thickening agent; and
about 10 wt % to about 50 wt % fat component,
wherein the fat component of the plant-based cream cheese product is in the form of oil droplets with a D50 value at 40° C. within the range of about 1.5 μm to about 7 μm.

2. The plant-based cream cheese product of claim 1, wherein the fat component of the plant-based cream cheese product is in the form of oil droplets with a D50 value at 40° C. within the range of about 1.5 μm to about 6.75 μm.

3. The plant-based cream cheese product of claim 1, wherein the fat component of the plant-based cream cheese product is in the form of oil droplets with a width of distribution of 5.0 μm or less.

4. The plant-based cream cheese product of claim 1, wherein the plant-based cheese product has a complex viscosity at a frequency of 10 rad/s and a temperature of 25° C. within the range of about 400 Pa·s to about 1200 Pa·s.

5. The plant-based cream cheese product of claim 1, wherein the plant-based cheese product has a complex viscosity at a frequency of 10 rad/s and a temperature of 25° C. within the range of about 400 Pa·s to about 1150 Pa·s.

6. The plant-based cream cheese product of claim 1, wherein the plant-based cheese product has an elastic modulus at a temperature of 25° C. within the range of about 4000 Pa to about 8000 Pa.

7. The plant-based cream cheese product of claim 1, wherein the fat component has a solid fat content within the range of about 50% to about 90% at 10° C. and about 15% to about 45% at 20° C.

8. The plant-based cream cheese product of claim 1, wherein the starch-based thickening agent is a shear tolerant starch.

9. The plant-based cream cheese product of claim 1, wherein the plant-based crude protein comprises one or more of faba bean protein, pea protein, and soy protein.

10. The plant-based cream cheese product of claim 1, wherein the plant-based crude protein is faba bean protein.

11. The plant-based cream cheese product of claim 1, wherein the fat component comprises one or more of coconut oil and sunflower oil.

12. The plant-based cream cheese product of claim 1, wherein the stabilizer comprises at least one hydrocolloid.

13. The plant-based cream cheese product of claim 1, wherein the stabilizer is present in an amount within the range of about 0.01 wt % to about 1 wt %, based on a total weight of the plant-based cream cheese product; and the starch-based thickening agent is present in an amount within the range of about 3 wt % to about 10 wt %, based on a total weight of the plant-based cream cheese product.

14. The plant-based cream cheese product of claim 1, wherein the fat component is present in an amount within the range of about 15 wt % to about 35 wt %, based on a total weight of the plant-based cream cheese product.

15. A method of making the plant-based cream cheese product of claim 1, comprising:
mixing water, a plant-based crude protein, a starch-based thickening agent, a stabilizer, and a fat component to form a mixture;
heating the mixture to a temperature within the range of about 150° F. to about 200° F.; and
homogenizing the heated mixture to form the plant-based cream cheese product.

16. The method of claim 15, further comprising adding an acidulant to the mixture to provide a pH within the range of about 3.5 to 5.0 in the plant-based cream cheese product.

17. The method of claim 15, wherein water is added to the mixture in an amount to provide a moisture % within the range of about 50% to about 80% in the plant-based cream cheese product.

18. A method of making the plant-based cream cheese product according to claim 1, comprising:
adding a plant-based protein to water to form a first mixture;
melting a fat component having a solid fat content within the range of about 50% to about 90% at 10° C. and about 15% to about 45% at 20° C.;
adding the melted fat component, a stabilizer, and a starch-based thickening agent to the first mixture and mixing to form a second mixture;
heating the second mixture to pasteurize the second mixture; and
homogenizing the second mixture to form the plant-based cream cheese product.

19. The method of claim 18, wherein heating of the second mixture is by direct steam injection to a temperature within the range of about 150° F. to about 200° F. for about 1 second to about 5 minutes.

20. The method of claim 18, wherein water is included in an amount to provide a moisture % within the range of about 50% to about 80% in the plant-based cream cheese product.
